(19) United States
(12) Patent Application Publication
(10) Pub. No.: US 2017/0220105 A1
(43) Pub. Date: Aug. 3, 2017

(54) INFORMATION PROCESSING APPARATUS, INFORMATION PROCESSING METHOD, AND STORAGE MEDIUM

(71) Applicant: CANON KABUSHIKI KAISHA, Tokyo (JP)

(72) Inventors: Naoko Ogata, Tokyo (JP); Hiroyuki Watabe, Tokyo (JP); Yasumi Tanaka, Funabashi-shi (JP)

(21) Appl. No.: 15/414,482

(22) Filed: Jan. 24, 2017

(30) Foreign Application Priority Data
Jan. 29, 2016 (JP) 2016-016364

(51) Int. Cl. G06F 3/01; G06T 19/20; G06T 19/00

(52) U.S. Cl. CPC G06F 3/012; G06T 19/006; G06T 19/20; G06T 2219/2016

(57) ABSTRACT

An information processing apparatus includes a viewpoint information storage unit configured to store viewpoint information for observing a virtual object as registered viewpoint information, a viewpoint position acquisition unit configured to acquire viewpoint information of a display apparatus mounted on a part of a body of a user, a setting unit configured to set viewpoint information for the user to observe a virtual object based on the registered viewpoint information and the acquired viewpoint information, a generation unit configured to generate a virtual image including the virtual object based on a viewpoint indicated by the set viewpoint information, and a display control unit configured to display the generated virtual image on the display apparatus.

### BACKGROUND

Field

The present disclosure relates to a technique for changing a viewpoint of a user who observes a virtual image.

Description of the Related Art

In recent years, with the aim of seamlessly combining a real space and a virtual space, a study of a mixed reality (MR) system has been carried out actively. A head-mounted display (HMD) can be used as an image display apparatus for providing the MR system.

Conventionally, in order to move and have an experience in a virtual space by wearing the HMD, a user practically moves around a real space to reflect the movement, or moves a viewpoint by using an input device such as a game controller, a mouse, or a keyboard. Alternatively, the user selects a pre-registered position (i.e., an object name or a place name) to move a viewpoint thereto (see Japanese Patent Application Laid-Open No. 2001-338311).

However, with the method discussed in Japanese Patent Application Laid-Open No. 2001-338331, if the pre-registered position is lower than the height of the user, sense of immersion will be impaired because a position of the feet becomes lower than a floor level. Further, there is a problem in that a line-of-sight direction of the registered viewpoint does not conform to the actual line-of-sight direction of the user, and thus the movement thereof lacks sense of reality.

### SUMMARY

According to an exemplary embodiment, an information processing apparatus includes a viewpoint information storage unit configured to store viewpoint information for observing a virtual object as registered viewpoint information, a viewpoint position acquisition unit configured to acquire viewpoint information of a display apparatus mounted on a part of a body of a user, a setting unit configured to set viewpoint information for the user to observe a virtual object based on the registered viewpoint information and the acquired viewpoint information, a generation unit configured to generate a virtual image including a virtual object based on a viewpoint indicated by the set viewpoint information, and a display control unit configured to display the generated virtual image on the display apparatus.

According to another exemplary embodiment, an information processing apparatus includes a viewpoint information storage unit configured to store a relative position between a viewpoint position for observing a virtual object and a position of the virtual object as a registered relative position, a viewpoint information acquisition unit configured to acquire a relative position between a viewpoint position of a display apparatus mounted on a part of a body of a user and a position of the virtual object, a setting unit configured to set a viewpoint position for the user to observe the virtual object so as to match the acquired relative position with the registered relative position, a generation unit configured to generate a virtual image including a virtual object based on the set viewpoint position, and a display control unit configured to display the generated virtual image on the display apparatus.

According to the exemplary embodiments, a viewpoint of the user who observes a virtual image can be moved without impairing sense of reality.

Further features will become apparent from the following description of exemplary embodiments with reference to the attached drawings.

### BRIEF DESCRIPTION OF THE DRAWINGS

FIG. 1 is a block diagram illustrating an example of a functional configuration of a system according to a first exemplary embodiment.

FIG. 2 is a flowchart illustrating processing of an information processing apparatus according to the first exemplary embodiment.

FIGS. 3A, 3B, and 3C are diagrams illustrating the first exemplary embodiment.

FIG. 4 is a block diagram illustrating an example of a functional configuration of a system according to a second exemplary embodiment.

FIG. 5 is a flowchart illustrating processing of an information processing apparatus according to the second exemplary embodiment.

FIGS. 6A, 6B, and 6C are diagrams illustrating the second exemplary embodiment.

FIG. 7 is a block diagram illustrating an example of a functional configuration of a system according to a third exemplary embodiment.

FIG. 8 is a flowchart illustrating processing of an information processing apparatus according to the third exemplary embodiment.

FIGS. 9A, 9B, and 9C are diagrams illustrating the third exemplary embodiment.

FIG. 10 is a block diagram illustrating an example of a functional configuration of a system according to a fourth exemplary embodiment.

FIG. 11 is a flowchart illustrating processing of an information processing apparatus according to the fourth exemplary embodiment.

FIGS. 12A, 12B, and 12C are diagrams illustrating the fourth exemplary embodiment.

FIG. 13 is a block diagram illustrating an example of a functional configuration of a system according to a fifth exemplary embodiment.

FIG. 14 is a flowchart illustrating processing of an information processing apparatus according to the fifth exemplary embodiment.

FIGS. 15A, 15B, and 15C are diagrams illustrating the fifth exemplary embodiment.

FIG. 16 is a block diagram illustrating an example of a functional configuration of a system according to a sixth exemplary embodiment.

FIG. 17 is a flowchart illustrating processing of an information processing apparatus according to the sixth exemplary embodiment.

FIGS. 18A, 18B, and 18C are diagrams illustrating the sixth exemplary embodiment.

FIG. 19 is a block diagram illustrating an example of a hardware configuration of the information processing apparatus according to an exemplary embodiment.

### DESCRIPTION OF THE EMBODIMENTS

Hereinbelow, exemplary embodiments will be described with reference to the appended drawings. In addition, the exemplary embodiments described below are merely examples, which are also specific exemplary embodiments of the configuration described in the claims.

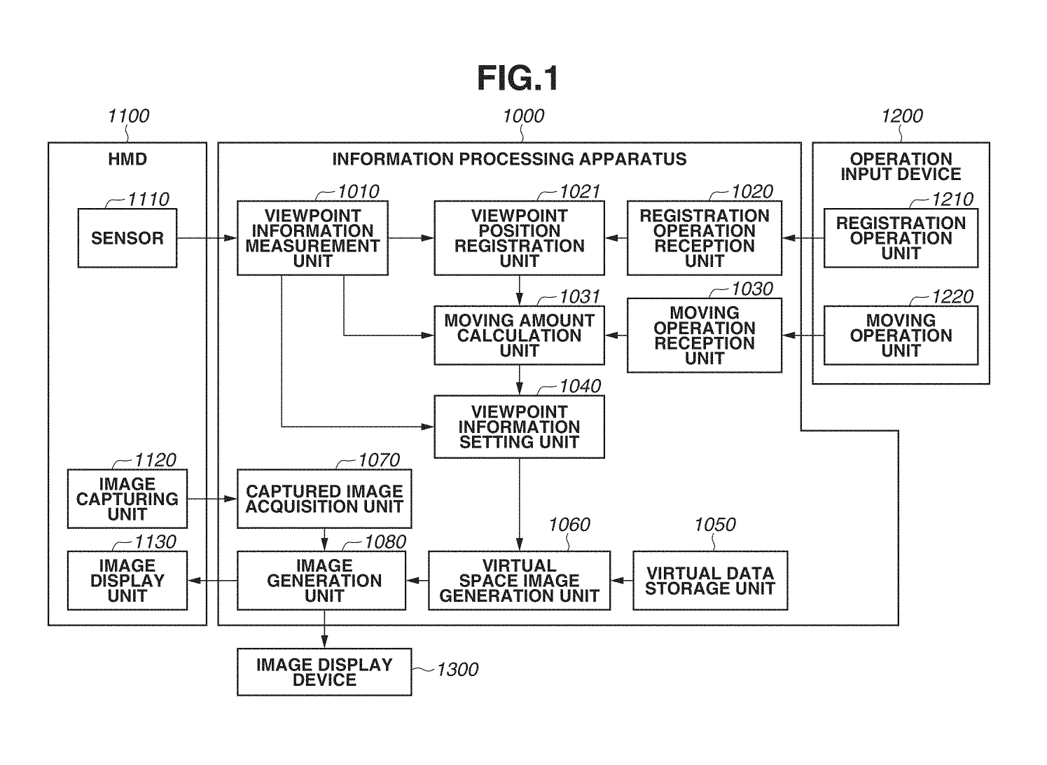

FIG. 1 is a block diagram illustrating an example of a functional configuration of a system according to a first exemplary embodiment. As illustrated in FIG. 1, the system according to the present exemplary embodiment is configured of an information processing apparatus 1000, a head-mounted display (HMD) 1100 as an example of a head-mounted display apparatus, an operation input device 1200, an image display device 1300, a magnetic field generation apparatus (not illustrated), and a virtual data input unit (not illustrated).

The information processing apparatus 1000 is configured of a viewpoint information measurement unit 1010, a registration operation reception unit 1020, a viewpoint position registration unit 1021, a moving operation reception unit 1030, a moving amount calculation unit 1031, a viewpoint information setting unit 1040, a virtual data storage unit 1050, a virtual space image generation unit 1060, a captured image acquisition unit 1070, and an image generation unit 1080.

The HMD 1100 is configured of a sensor 1110, an image capturing unit 1120, and an image display unit 1130. The information processing apparatus 1000 and the HMD 1100 are communicably connected. The connection between the information processing apparatus 1000 and the HMD 1100 may be wired or wireless connection. The operation input device 1200 is configured of a registration operation unit 1210 and a movement operation unit 1220.

First, the information processing apparatus 1000 will be described.

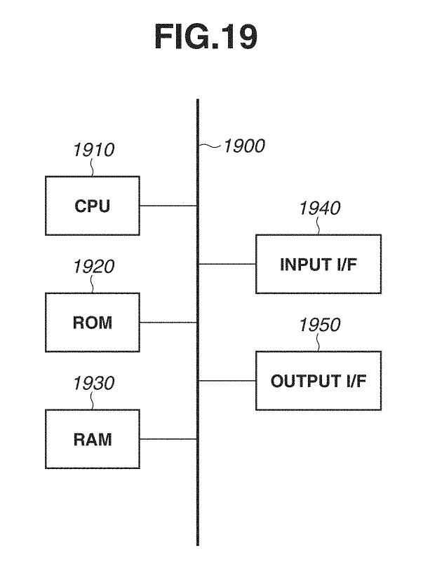

FIG. 19 is a block diagram illustrating a hardware configuration of the information processing apparatus 1000 according to the present exemplary embodiment. In FIG. 19, a central processing unit (CPU) 1910 generally controls respective devices connected thereto via a bus 1900. The CPU 1910 reads and executes processing steps or programs stored in a read only memory (ROM) 1920. An operating system (OS), various processing programs according to the present exemplary embodiment, and a device driver are stored in the ROM 1920, temporarily stored in a random access memory (RAM) 1930, and executed by the CPU 1910 as appropriate. An input interface (I/F) 1940 receives data from an external apparatus such as a display apparatus or an operation apparatus as an input signal in a format processable by the information processing apparatus 1000. An output I/F 1950 outputs data to an external apparatus such as a display apparatus as an output signal in a format processable by the display apparatus.

The viewpoint information measurement unit 1010 uses a measurement result of the sensor 1110 to measure a viewpoint position and an observing direction (hereinafter, referred to as “line-of-sight direction”) of the viewpoint in a world coordinate system of the sensor 1110 as the viewpoint information. With this configuration, the viewpoint information of the HMD 1100 can be measured. In addition, the world coordinate system defines one point in a real space as an origin, and further defines three axes orthogonal to each other as an X-axis, a Y-axis, and a Z-axis respectively.

The registration operation reception unit 1020 receives an event input through the registration operation unit 1210 and prompts the viewpoint position registration unit 1021 to execute registration.

According to the instruction from the registration operation reception unit 1020, the viewpoint position registration unit 1021 registers and stores the viewpoint position measured by the viewpoint information measurement unit 1010 as a registered relative position (stored viewpoint position). This viewpoint position is a viewpoint position (registered viewpoint position) for a user to observe a virtual object through the HMD 1100 mounted on a head as a part of the user's body. As described above, the viewpoint position may be registered by using an actually measured value, or may be input through a mouse or keyboard operated by the user. Although details will be described below, the user who observes the virtual object through the HMD 1100 can change a current viewpoint position by referring to the viewpoint position registered by the viewpoint position registration unit 1021.

The moving operation reception unit 1030 receives an event input through the moving operation unit 1220 and prompts the moving amount calculation unit 1031 to calculate a moving amount.

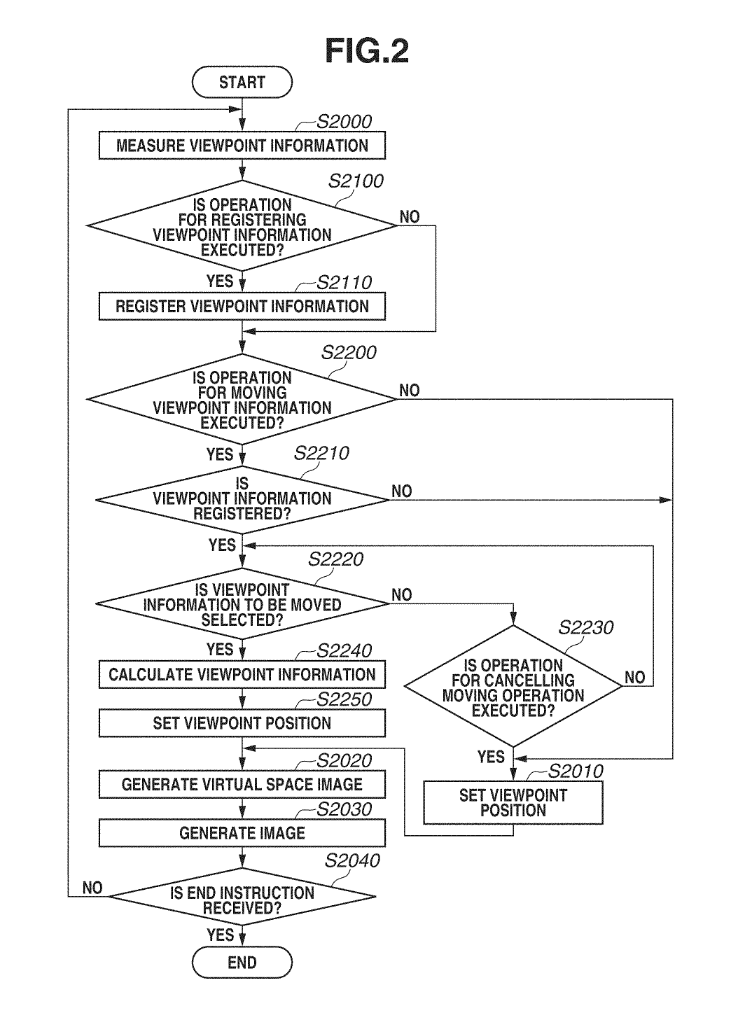

The moving amount calculation unit 1031 calculates a moving amount for moving a viewpoint position (acquired viewpoint position) measured by the viewpoint information measurement unit 1010 to a viewpoint position registered by the viewpoint position registration unit 1021. Details will be described below with reference to a flowchart in FIG. 2.

When the moving operation reception unit 1030 receives the event from the moving operation unit 1220, the viewpoint information setting unit 1040 sets a viewpoint position on which a moving amount received from the moving amount calculation unit 1031 is reflected to the viewpoint information. Further, the viewpoint information setting unit 1040 sets the line-of-sight direction measured by the viewpoint information measurement unit 1010 to the viewpoint information of the virtual space. When the moving operation reception unit 1030 has not received the event from the moving operation unit 1220, the viewpoint information setting unit 1040 sets the viewpoint position and the line-of-sight direction measured by the viewpoint information measurement unit 1010 as the viewpoint information of the virtual space. Then, the viewpoint information setting unit 1040 outputs the set viewpoint information to the virtual space image generation unit 1060.

The virtual data storage unit 1050 stores data about a virtual space such as data relating to a virtual object for constituting the virtual space and data relating to a light source for irradiating the virtual space, and inputs the data to the virtual space image generation unit 1060.

The virtual space image generation unit 1060 generates the data of the virtual space input from the virtual data storage unit 1050 viewed from the viewpoint position and the line-of-sight, input from the viewpoint information setting unit 1040 as an image of the virtual space image (virtual image). In addition, because a technique for generating an image of the virtual space viewed from a predetermined viewpoint position is a known technique, details thereof will not be described.

The captured image acquisition unit 1070 acquires an image of a real space (real space image) captured by the image capturing unit 1120.

The image generation unit 1080 superimposes the virtual space image onto the real space image acquired by the captured image acquisition unit 1070 and generates an image of a mixed reality space (mixed reality space image). Thereafter, the image generation unit 1080 outputs the generated mixed reality image to the image display unit 1130 of the HMD 1100 (display control). Further, the mixed reality image may be displayed on the image display device 1300 simultaneously. Further, any apparatus capable of displaying an image or a display terminal such as a tablet or a smartphone may be used other than the HMD 1100.

The CPU 1910 realizes the respective function units by loading a program stored in the ROM 1920 to the RAM 1930 and executes the processing according to the flowcharts described below. Further, for example, if hardware is configured as an alternative to the software processing using the CPU 1910, a calculation unit or a circuit corresponding to the processing of the respective function units described below may be configured.

Next, the HMD 1100 will be described.

The HMD 1100 is a display apparatus configured of right-eye and left-eye liquid crystal displays, which are respectively attached to the HMD 1100 so as to be arranged in front of the right and the left eyes of the user who puts the HMD 1100 on the head. Further, respective images having right/left disparity are displayed on the right and the left displays stereographically.

The sensor 1110 is a magnetic sensor for measuring the viewpoint information of the HDM 1100, which measures changes in a magnetic field generated by a magnetic field generation apparatus (not illustrated), and inputs the measurement result to the information processing apparatus 1000. In the present exemplary embodiment, although the sensor 1110 will be described as a magnetic sensor, a sensor other than the magnetic sensor may be used. For example, the viewpoint position and the line-of-sight direction may be measured by extracting feature information such as a dot or a line in the image through image processing. Further, the viewpoint position and the line-of-sight direction may be measured by using infrared light, or may be measured by using an ultrasonic wave. Furthermore, the viewpoint position and the line-of-sight direction may be measured by using a depth sensor, or may be measured mechanically.

The image capturing unit 1120 captures a real space displayed on the HMD 1100 and inputs the captured image to the information processing apparatus 1000 as a real space image.

The image display unit 1130 displays the mixed reality image generated by the information processing apparatus 1000. As described above, in the present exemplary embodiment, the HMD 1100 will be described as a video see-through type HMD which displays a mixed reality image generated based on the image captured by an image-capturing apparatus, on a display apparatus. However, an optical see-through type HMD that superimposes and displays a virtual image on a display medium through which a real space is observable may be used as the HMD 1100.

The operation input device 1200 is an apparatus through which a user's operation can be input to the information processing apparatus 1000. The registration operation unit 1210 is used for registering the viewpoint information. Further, the moving operation unit 1220 is used for selecting and moving a registered viewpoint position to be moved. Any input device such as a mouse or a keyboard (keypad type device) may be used as the operation input device 1200 as long as the above-described purposes can be achieved. Further, the operation input device 1200 may be an apparatus that receives an operation by recognizing a user's gesture or voice.

FIG. 2 is a flowchart illustrating processing executed by the information processing apparatus 1000 to generate and output a mixed reality space image to the HMD 1100 or the image display device 1300.

First, in step S2000, the viewpoint information measurement unit 1010 measures a viewpoint position and a line-of-sight direction of the HMD 1100 in the world coordinate system. Then, the processing proceeds to step S2100.

In step S2100, the registration operation reception unit 1020 refers to the input information from the registration operation unit 1210 and checks whether an operation for registering viewpoint information is input. If the operation for registering the viewpoint information is input (YES in step S2100), the processing proceeds to step S2110. On the other hand, if the operation for registering the viewpoint information is not input (NO in step S2100), the processing proceeds to step S2200.

In step S2110, the viewpoint position registration unit 1021 refers to the information from the viewpoint information measurement unit 1010 and registers the viewpoint position. Then, the processing proceeds to step S2200.

In step S2200, the moving operation reception unit 1030 refers to the input information from the moving operation unit 1220 and checks whether an operation for moving the viewpoint information is input. If the operation for moving the viewpoint information is input (YES in step S2200), the processing proceeds to step S2210. On the other hand, if the operation for moving the viewpoint information is not input (NO in step S2200), the processing proceeds to step S2010.

In step S2210, the viewpoint position registration unit 1021 checks whether the viewpoint information is registered. If the viewpoint information is registered (YES in step S2210), the processing proceeds to step S2220. On the other hand, if the viewpoint information is not registered (NO in step S2210), the processing proceeds to step S2010.

In step S2220, the moving operation reception unit 1030 refers to the input information from the moving operation unit 1220 and checks whether viewpoint information to be moved is selected from the registered viewpoint information. If the viewpoint information to be moved is selected from the registered viewpoint information (YES in step S2220), the processing proceeds to step S2240.

If the viewpoint information to be moved is not selected from the registered viewpoint information (NO in step S2220), the processing proceeds to step S2230.

In step S2230, the moving operation reception unit 1030 refers to the input information from the moving operation unit 1220 and checks whether an operation for cancelling the moving operation is input. If the operation for cancelling the moving operation is input (YES in step S2230), the processing proceeds to step S2010. If the operation for cancelling the moving operation is not input (NO in step S2230), the processing proceeds to step S2220.

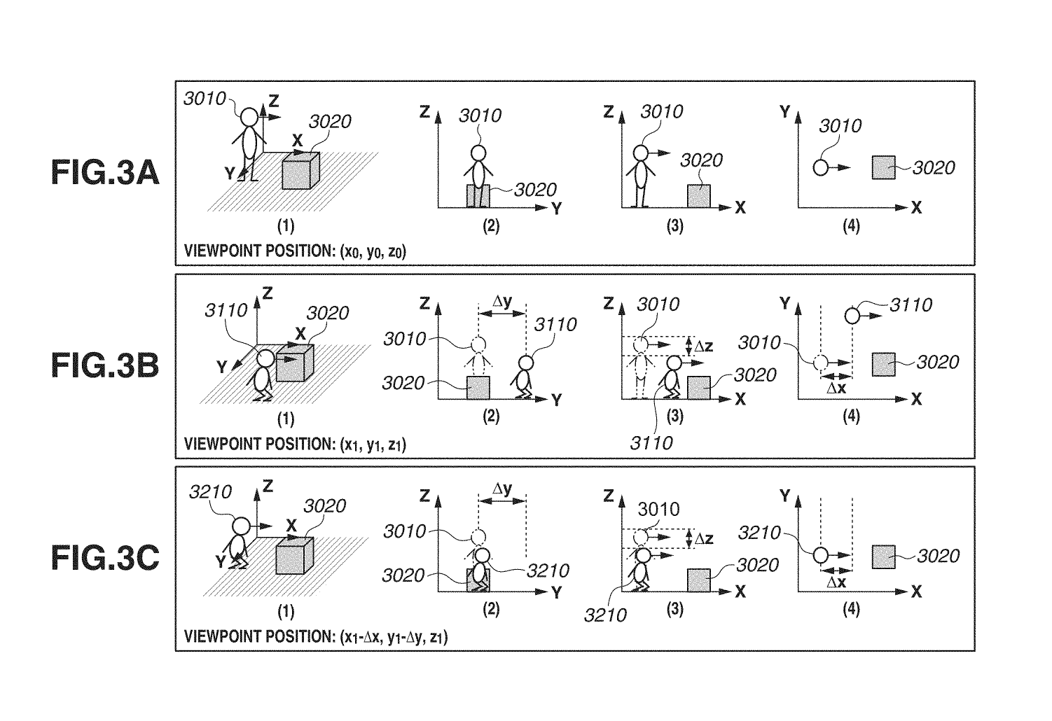

The processing in steps 52240 and 52250 will be described with reference to FIGS. 3A, 3B, and 3C.

FIGS. 3A, 3B, and 3C are diagrams each illustrating an operation for moving a viewpoint position to a viewpoint position of the registered viewpoint information using the present exemplary embodiment. FIG. 3A is a diagram illustrating a viewpoint position of a user 3010 and a virtual object 3020 at the time of registration. FIG. 3B is a diagram illustrating a viewpoint position of a user 3110 and the virtual object 3020 before the operation for moving the viewpoint position is executed. FIG. 3C is a diagram illustrating a viewpoint position of a user 3210 and the virtual object 3020 after the operation for moving the viewpoint position is executed.

FIG. 3A (1) is a diagram three-dimensionally illustrating a virtual space at the time of registration. Further, FIG. 3A (2) is a diagram illustrating a state where FIG. 3A (1) is viewed in a direction of the X-axis, FIG. 3A (3) is a diagram illustrating a state where FIG. 3A (1) is viewed in a direction of the Y-axis, and FIG. 3A (4) is a diagram illustrating a state where FIG. 3A (1) is viewed from above in a direction of the Z-axis.

FIG. 3B (1) is a diagram three-dimensionally illustrating a virtual space before the operation for moving the viewpoint position is executed. Further, FIG. 3B (2) is a diagram illustrating a state where FIG. 3B (1) is viewed in a direction of the X-axis, FIG. 3B (3) is a diagram illustrating a state where FIG. 3B (1) is viewed in a direction of the Y-axis, and FIG. 3B (4) is a diagram illustrating a state where FIG. 3B (1) is viewed from above in a direction of the Z-axis.

FIG. 3C (1) is a diagram three-dimensionally illustrating a virtual space after the operation for moving the viewpoint position is executed. Further, FIG. 3C (2) is a diagram illustrating a state where FIG. 3C (1) is viewed in a direction of the X-axis, FIG. 3C (3) is a diagram illustrating a state where FIG. 3C (1) is viewed in a direction of the Y-axis, and FIG. 3C (4) is a diagram illustrating a state where FIG. 3C (1) is viewed from above in a direction of the Z-axis.

In step S2240, a viewpoint position of the registered viewpoint information selected in step S2220 is expressed as (x₀, y₀, z₀) in the world coordinates. Further, a viewpoint position of the user 3110 at the time of executing the processing in step S2240, i.e., before executing the moving operation, i.e., a viewpoint position of the user 3110, is expressed as (x₁, y₁, z₁) in the world coordinates. At this time, the moving amount calculation unit 1031 calculates a moving amount (difference amount) (Δx, Δy, Δz) for moving the viewpoint position (c₁, y₁, z₁) of the user 3110 before the moving operation to the viewpoint position (x₀, y₀, z₀) of the registered viewpoint information. Then, the processing proceeds to step S2250.

In step S2250, the viewpoint information setting unit 1040 takes a viewpoint height into consideration, and sets a viewpoint position on which the moving amount is reflected to the viewpoint information. In other words, as illustrated in FIG. 3C, the viewpoint information setting unit 1040 does not reflect the moving amount in the Z-axis direction (height direction), and sets a viewpoint position (x₁−Δx, y₁−Δy, z₁) of the user 3210 in the world coordinates after the moving operation to the viewpoint information (i.e., components except for the height component are reflected). Then, the processing proceeds to step S2020.

In step S2010, the viewpoint information setting unit 1040 sets the viewpoint position measured by the viewpoint information measurement unit 1010 to the viewpoint information. Then, the processing proceeds to step S2020.

In step S2020, the virtual space image generation unit 1060 generates a virtual space image from the viewpoint information set in step S2010 or 52250 and the virtual data input from the virtual data storage unit 1050. Then, the processing proceeds to step S2030.

In step S2030, the image generation unit 1080 superimposes the virtual space image generated by the virtual space image generation unit 1060 on the real space image acquired by the captured image acquisition unit 1070, and generates a mixed reality image. The generated mixed reality image is output to the image display unit 1130 of the HMD 1100 or the image display device 1300. Then, the processing proceeds to step S2040.

In step S2040, if an instruction for ending the processing is input by the user or a condition of ending the processing is satisfied (YES in step S2040), the processing is ended. On the other hand, if the instruction for ending the processing is not input or the condition of ending the processing is not satisfied (NO in step S2040), the processing returns to step S2000.

According to the present exemplary embodiment, for example, when a user A registers a viewpoint position while a user B having a height different from the height of the user A executes the moving operation, the viewpoint is moved to the viewpoint position registered by the user A while maintaining the viewpoint height of the user B, so that the viewpoint can be moved without impairing the sense of reality.

Therefore, according to the present exemplary embodiment, in the viewpoint moving operation of the mixed reality space, a viewpoint can be moved while maintaining the user's viewpoint height by reflecting only a part of the components of the registered viewpoint position, so that a moving operation which does not impair the sense of reality can be provided.

### MODIFICATION EXAMPLE 1

In the above-described exemplary embodiment, when the viewpoint position is moved, the moving operation for moving the viewpoint while maintaining the user's viewpoint height is executed constantly. However, the present invention is not limited thereto. In other words, the information processing apparatus may select whether to move the viewpoint while maintaining the viewpoint height of a movement-operating user or to move the viewpoint to the viewpoint height of the user at the time of registration.

In the first exemplary embodiment, the processing for registering a viewpoint position, calculating a moving amount, and setting a viewpoint information has been described. In a second exemplary embodiment, processing for moving a line-of-sight direction will be described.

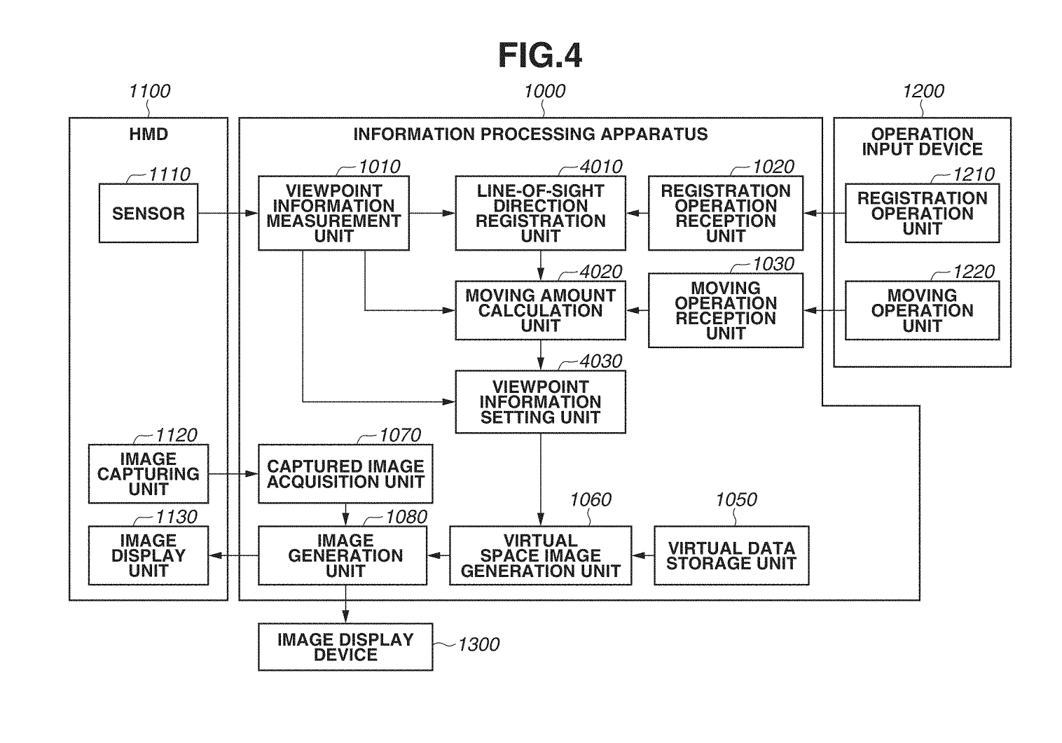

FIG. 4 is a block diagram illustrating an example of a functional configuration of a system according to the present exemplary embodiment. The same reference numerals are applied to the same constituent elements as those illustrated in FIG. 1, and the description thereof will be omitted.

A line-of-sight direction registration unit 4010 registers and stores a line-of-sight direction measured by a viewpoint information measurement unit 1010 as a registered line-of-sight direction (line-of-sight direction storage). The line-of-sight direction may be registered by using an actually measured value, or may be input through a mouse or a keyboard operated by a user.

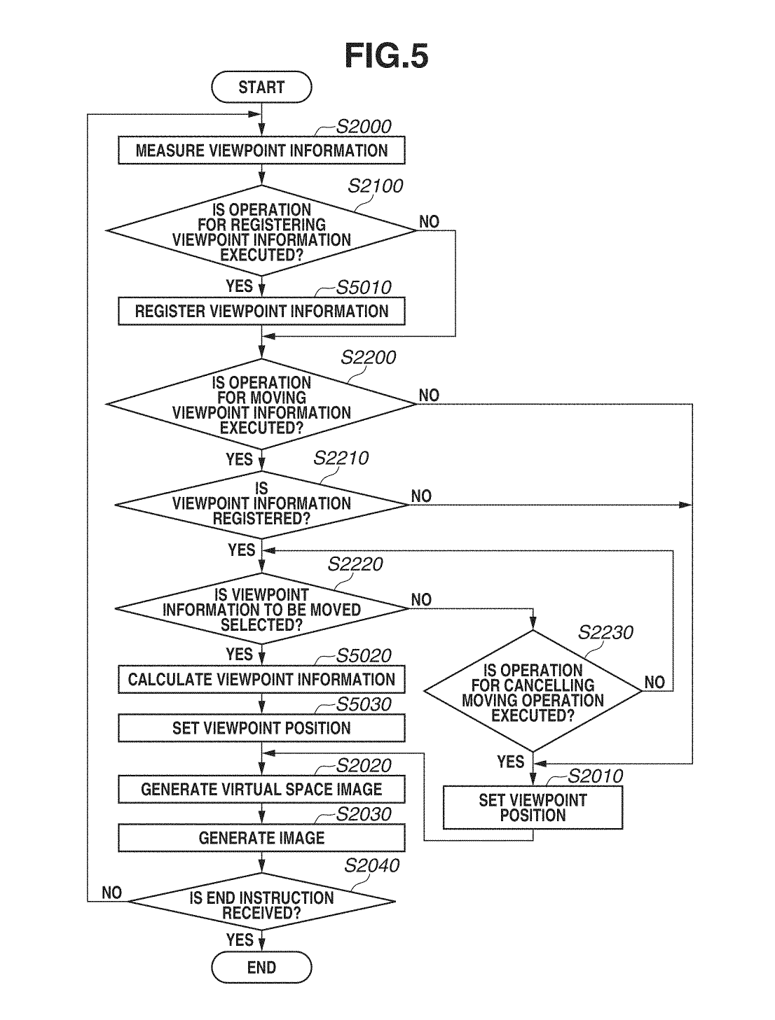

A moving amount calculation unit 4020 calculates a moving amount for moving the line-of-sight direction (line-of-sight direction acquisition) measured by the viewpoint information measurement unit 1010 to the registered line-of-sight direction registered by the line-of-sight direction registration unit 4010. Details thereof will be described below with reference to a flowchart in FIG. 5.

When a moving operation reception unit 1030 receives an event from a moving operation unit 1220, a viewpoint information setting unit 4030 sets a viewpoint position measured by the viewpoint information measurement unit 1010 to the viewpoint information. Further, the viewpoint information setting unit 4030 sets a line-of-sight direction, on which the moving amount calculated by the moving amount calculation unit 4020 is reflected, to the viewpoint information of the virtual space. When the moving operation reception unit 1030 does not receive the event from the moving operation unit 1220, the viewpoint information setting unit 4030 sets the viewpoint position and the line-of-sight direction measured by the viewpoint information measurement unit 1010, to the viewpoint information of the virtual space.

FIG. 5 is a flowchart illustrating processing for moving the line-of-sight direction measured by the viewpoint information measurement unit 1010 to the registered line-of-sight direction registered by the line-of-sight direction registration unit 4010 based on the moving amount calculated by the moving amount calculation unit 4020. The same reference numerals are applied to the constituent elements as those illustrated in FIG. 2, and the description thereof will be omitted.

In step S5010, the line-of-sight direction registration unit 4010 refers to the information from the viewpoint information measurement unit 1010 and registers the line-of-sight direction as a registered line-of-sight direction. Then, the processing proceeds to step S2200.

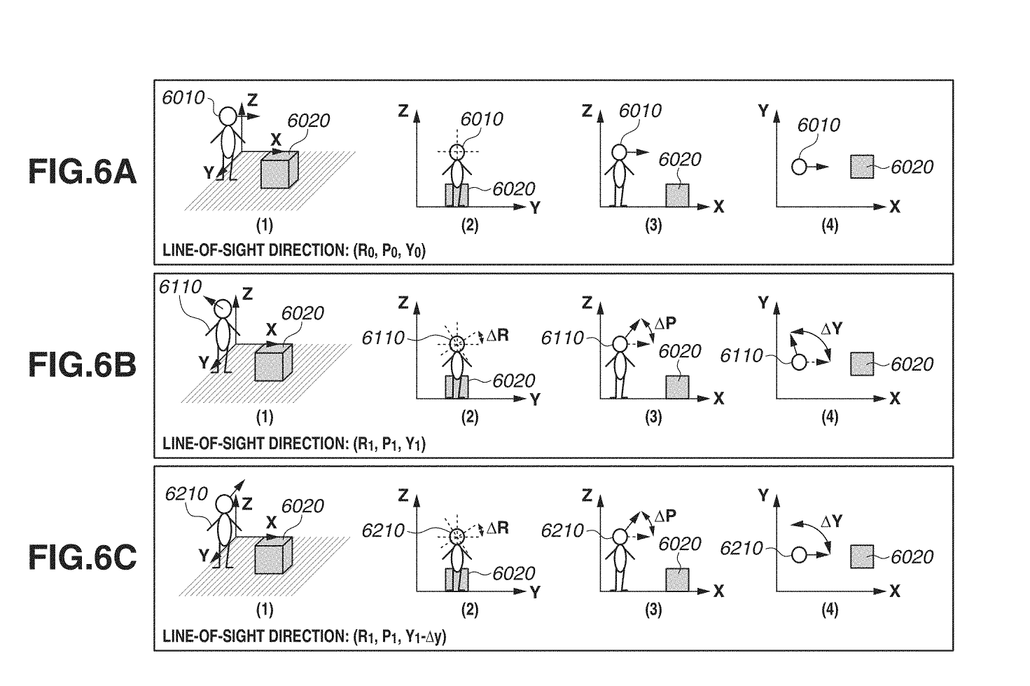

The processing in steps S5020 and S5030 will be described with reference to FIGS. 6A, 6B, and 6C. The same reference numerals are applied to the constituent elements as those illustrated in FIGS. 3A, 3B, and 3C, and the description thereof will be omitted.

FIGS. 6A, 6B, and 6C are diagrams illustrating an operation for moving a line-of-sight direction to the line-of-sight direction of the registered viewpoint information according to the present exemplary embodiment. FIG. 6A is a diagram illustrating a line-of-sight direction of a user 6010 and a virtual object 6020 at the time of registration. FIG. 6B is a diagram illustrating a line-of-sight direction of a user 6110 and the virtual object 6020 before the operation for moving a line-of-sight direction is executed. FIG. 6C is a diagram illustrating a line-of-sight direction of a user 6210 and the virtual object 6020 after the operation for moving a line-of-sight direction is executed. The line-of-sight direction is defined by setting the viewpoint position measured by the viewpoint information measurement unit 1010 as an origin. Further, the line-of-sight direction is expressed by rotation angles (roll angle, pitch angle, and yaw angle) of respective axes in a coordinate system in which three axes orthogonal to each other are respectively defined as a roll axis, a pitch axis, and a yaw axis. At this time, the yaw axis has an axis in a gravitational direction.

In the present exemplary embodiment, although a viewpoint position in the world coordinate system and a line-of-sight direction in the coordinate system using a roll axis, a pitch axis, and a yaw axis, which use the viewpoint position as an origin, have been used, the present invention is not limited thereto. In other words, viewpoint information may be set by calculating a moving amount so as to maintain a relative position between the viewpoint position and the position of the virtual object or a relative direction between the line-of-sight direction and the direction of the virtual object.

FIG. 6A (1) is a diagram three-dimensionally illustrating a virtual space at the time of registration. Further, FIG. 6A (2) is a diagram illustrating a state where FIG. 6A (1) is viewed in a direction of the X-axis, FIG. 6A (3) is a diagram illustrating a state where FIG. 6A (1) is viewed in a direction of the Y-axis, and FIG. 6A (4) is a diagram illustrating a state where FIG. 6A (1) is viewed from above in a direction of the Z-axis.

FIG. 6B (1) is a diagram three-dimensionally illustrating a virtual space before the operation for moving the line-of-sight direction is executed. Further, FIG. 6B (2) is a diagram illustrating a state where FIG. 6B (1) is viewed in a direction of the X-axis, FIG. 6B (3) is a diagram illustrating a state where FIG. 6B (1) is viewed in a direction of the Y-axis, and FIG. 6B (4) is a diagram illustrating a state where FIG. 6B (1) is viewed from above in a direction of the Z-axis.

FIG. 6C (1) is a diagram three-dimensionally illustrating a virtual space after the operation for moving the line-of-sight direction is executed. Further, FIG. 6C (2) is a diagram illustrating a state where FIG. 6C (1) is viewed in a direction of the X-axis, FIG. 6C (3) is a diagram illustrating a state where FIG. 6C (1) is viewed in a direction of the Y-axis, and FIG. 6C (4) is a diagram illustrating a state where FIG. 6C (1) is viewed from above in a direction of the Z-axis.

In step S5020, the line-of-sight direction of the registered viewpoint information selected in step S2220, i.e., a line-of-sight direction of the user 6010 at the time of registration, is expressed as (R₀, P₀, Y₀). Further, a line-of-sight direction of the user 6110 at the time of executing the processing in step S5020, i.e., a line-of-sight direction thereof before the operation for moving the line-of-sight direction is executed, is expressed as (R₁, P₁, Y₁). At this time, the moving amount calculation unit 4020 calculates a moving amount (ΔR, ΔP, ΔY) for moving the line-of-sight direction (R₁, P₁, Y₁) of the user 6110 before the moving operation to the line-of-sight direction (R₀, P₀, Y₀) of the user 6010 at the time of registration. Then, the processing proceeds to step S5030.

In step S5030, the viewpoint information setting unit 4030 sets the line-of-sight direction on which the moving amount is reflected to the viewpoint information without impairing the sense of reality. In other words, as illustrated in FIG. 6C, the viewpoint information setting unit 4030 reflects only a rotation about the yaw axis, and sets a line-of-sight direction (R₁, P₁, Y₁−ΔY), i.e., a line-of-sight direction on which components except for a yaw component are reflected, to the viewpoint information.

According to the present exemplary embodiment, in the viewpoint moving operation of the mixed reality space, the line-of-sight direction can be moved while maintaining the line-of-sight directions of the roll angle and the pitch angle, so that a moving operation which does not impair the sense of reality can be provided.

### MODIFICATION EXAMPLE 2

Although the operation for moving the viewpoint position and the operation for moving the line-of-sight direction have been separately described in the first and the second exemplary embodiments, the present invention is not limited thereto. The moving operation of a viewpoint position described in the first exemplary embodiment and the moving operation of a line-of-sight direction described in the second exemplary embodiment may be executed simultaneously. Further, the user may select whether to move only one or both of the viewpoint position and the line-of-sight direction.

### MODIFICATION EXAMPLE 3

In the first and the second exemplary embodiments, in order to set a new viewpoint position or a new line-of-sight direction, a moving amount from a registered viewpoint position or a registered line-of-sight direction has been calculated and reflected. However, components of the registered viewpoint position or components of the registered line-of-sight direction may be set to the components other than the height component or the yaw component, and a component of the current viewpoint position or a component of the current line-of-sight direction may be set to the height component or the yaw component without calculating the moving amount.

### MODIFICATION EXAMPLE 4

In the second exemplary embodiment, the moving operation for reflecting only a rotation about the yaw axis is executed constantly when a line-of-sight direction is moved. However, the present invention is not limited thereto. In other words, a moving operation that reflects all of the rotations about the roll axis, the pitch axis, and the yaw axis may be executed to reproduce the line-of-sight direction at the time of registration. Further, the user may select whether to move the viewpoint along with the movement of the line-of-sight direction.

In the first and the second exemplary embodiments, the description has been given of the viewpoint information moving operation that is executed when the viewpoint position or the line-of-sight direction is changed after registration of the viewpoint information. In a third exemplary embodiment, a description will be given of a viewpoint information moving operation that is executed when a virtual object in a virtual space is moved in parallel to the world coordinate system.

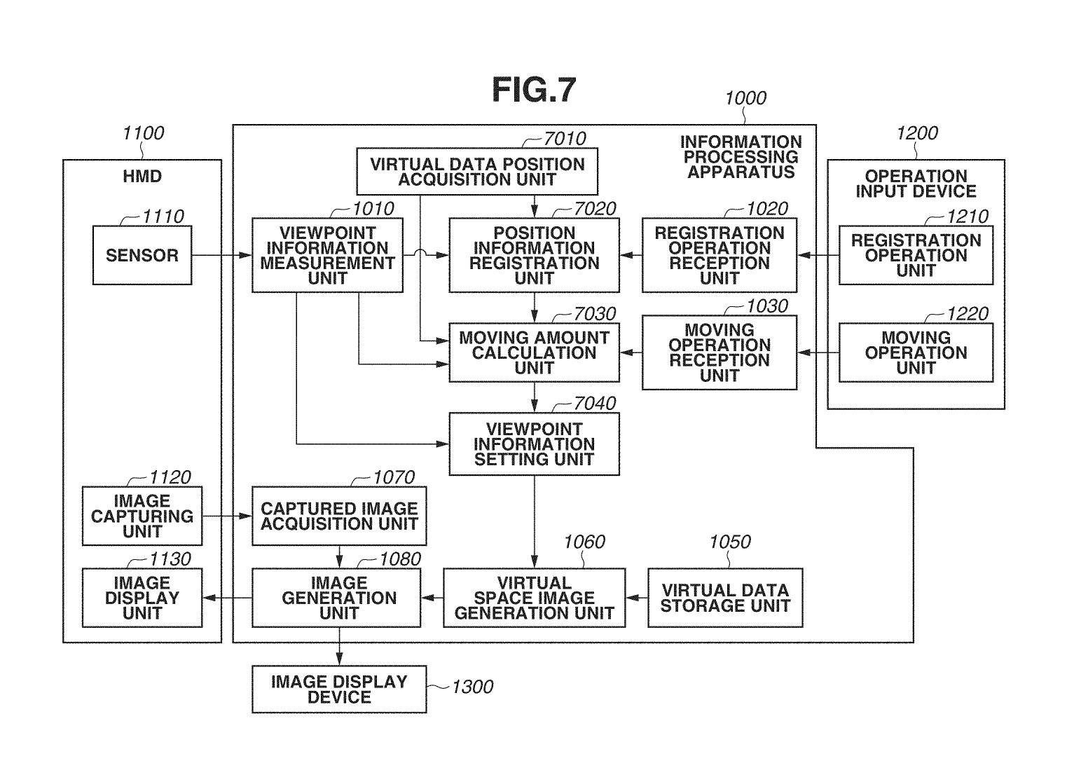

FIG. 7 is a block diagram illustrating an example of a functional configuration of a system according to the present exemplary embodiment. The same reference numerals are applied to the same constituent elements as those illustrated in FIG. 1, and description thereof will be omitted.

A virtual data position acquisition unit 7010 acquires a position of a virtual object in the world coordinate system.

A position information registration unit 7020 registers a viewpoint position measured by a viewpoint information measurement unit 1010 and the position of the virtual object acquired by the virtual data position acquisition unit 7010, and stores a relative position between the viewpoint position and the position of the virtual object as a registered relative position.

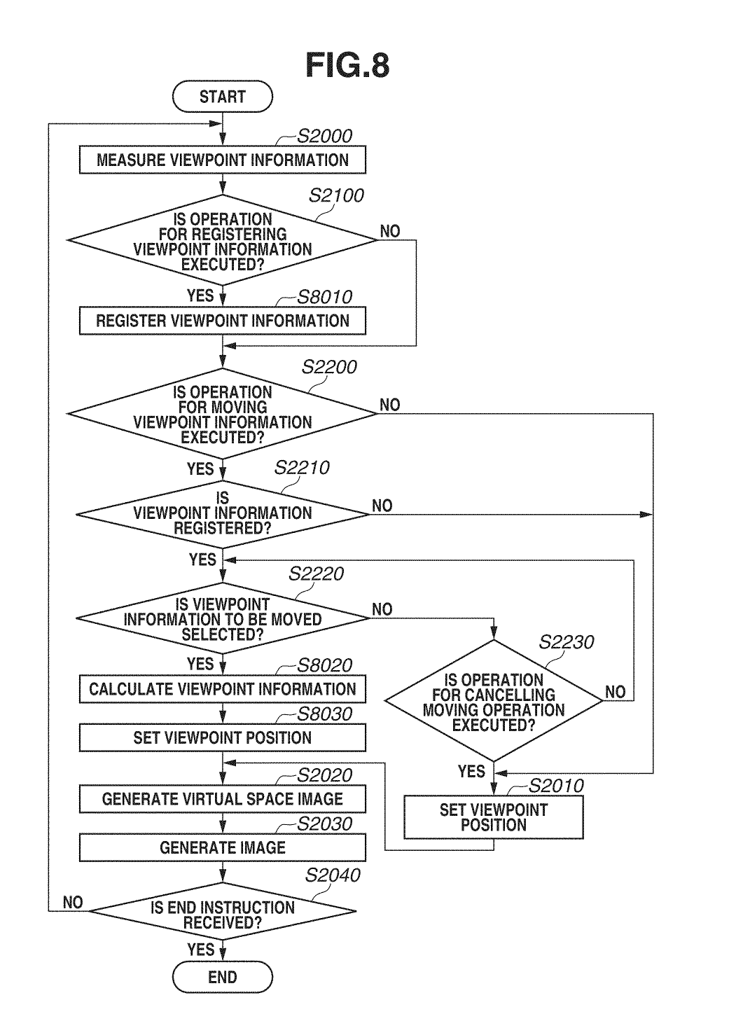

A moving amount calculation unit 7030 calculates a moving amount so as to reproduce a relative position between the viewpoint position and the position of the virtual object registered by the position information registration unit 7020. Details thereof will be described below with reference to a flowchart in FIG. 8.

FIG. 8 is a flowchart illustrating processing for moving the viewpoint position measured by the viewpoint information measurement unit 1010 based on the moving amount calculated by the moving amount calculation unit 7030 so as to reproduce a relative position between the viewpoint position and the position of the virtual object registered by the position information registration unit 7020. The same reference numerals are applied to the same constituent elements as those illustrated in FIG. 2, and description thereof will be omitted.

In step S8010, the position information registration unit 7020 refers to the information from the viewpoint information measurement unit 1010 and registers the viewpoint position. Further, the position information registration unit 7020 refers to the information from the virtual data position acquisition unit 7010 and registers the position of the virtual object. Then, the processing proceeds to step S2200.

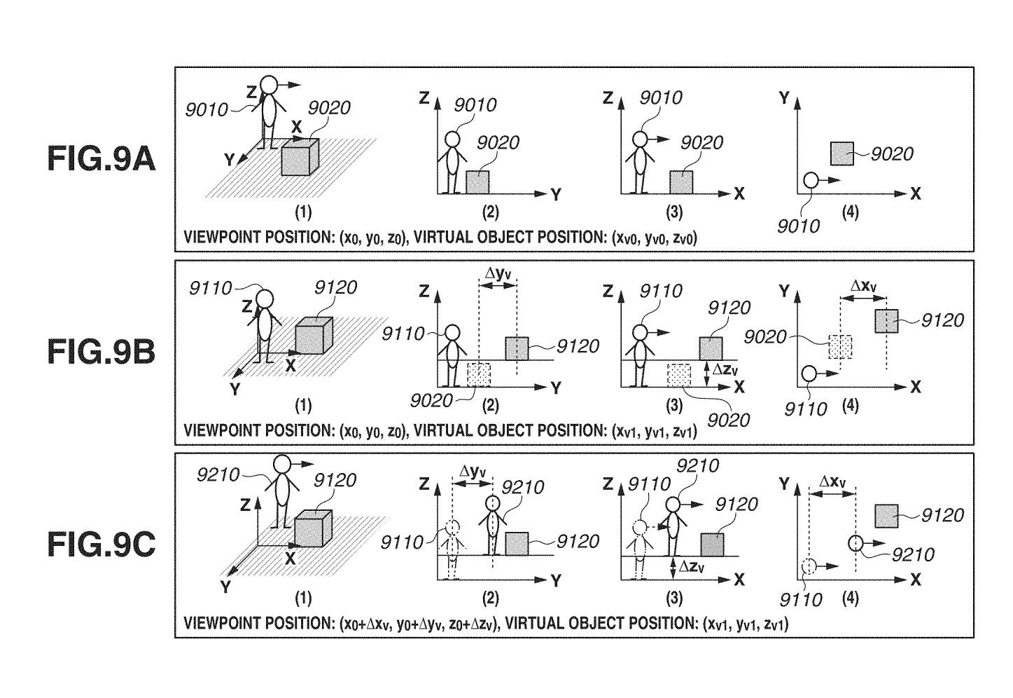

The processing performed in steps S8020 and S8030 will be described with reference to FIGS. 9A, 9B, and 9C.

FIGS. 9A, 9B, and 9C are diagrams illustrating an operation for moving the viewpoint position so as to reproduce a relative position between the viewpoint position of the registered viewpoint information and the position of the virtual object. FIG. 9A is a diagram illustrating a viewpoint position of a user 9010 and a virtual object 9020 at the time of registration. FIG. 9B is a diagram illustrating a viewpoint position of a user 9110 in the world coordinate system which is the same as the viewpoint position at the time of registration, a virtual object 9120 moved after the registration, and the virtual object 9020 at the time of registration. FIG. 9C is a diagram illustrating a viewpoint position of a user 9210 after the operation for moving the viewpoint position is executed, the user 9110 before the moving operation, and the virtual object 9120 moved after the registration.

FIG. 9A (1) is a diagram three-dimensionally illustrating a virtual space at the time of registration. Further, FIG. 9A (2) is a diagram illustrating a state where FIG. 9A (1) is viewed in a direction of the X-axis, FIG. 9A (3) is a diagram illustrating a state where FIG. 9A (1) is viewed in a direction of the Y-axis, and FIG. 9A (4) is a diagram illustrating a state where FIG. 9A (1) is viewed from above in a direction of the Z-axis.

FIG. 9B (1) is a diagram three-dimensionally illustrating a virtual space before the operation for moving the viewpoint position is executed, in which a position of the virtual object 9120 has been moved after the registration. Further, FIG. 9B (2) is a diagram illustrating a state where FIG. 9B (1) is viewed in a direction of the X-axis, FIG. 9B (3) is a diagram illustrating a state where FIG. 9B (1) is viewed in a direction of the Y-axis, and FIG. 9B (4) is a diagram illustrating a state where FIG. 9B (1) is viewed from above in a direction of the Z-axis.

FIG. 9C (1) is a diagram three-dimensionally illustrating a virtual space after the operation for moving the viewpoint position is executed.

Further, FIG. 9C (2) is a diagram illustrating a state where FIG. 9C (1) is viewed in a direction of the X-axis, FIG. 9C (3) is a diagram illustrating a state where FIG. 9C (1) is viewed in a direction of the Y-axis, and FIG. 9C (4) is a diagram illustrating a state where FIG. 9C (1) is viewed from above in a direction of the Z-axis.

In step S8020, the moving amount calculation unit 7030 calculates a moving amount of the virtual object for reproducing the registered relative position. A viewpoint position of the registered viewpoint information selected in step S2220 is expressed as (x₀, y₀, z₀) in the world coordinate system. Further, a virtual object position of the registered viewpoint information is expressed as (xᵥ₀, yᵥ₀, zᵥ₀) in the world coordinate system. A virtual object position of the virtual object 9120 at the time of executing the processing in step S8020, i.e., a virtual object position thereof before the operation for moving the viewpoint position is executed, is expressed as (xᵥ₁, yᵥ₁, zᵥ₁) in the world coordinate system. The moving amount calculation unit 7030 calculates a moving amount (Δxᵥ, Δyᵥ, Δzᵥ) for moving the virtual object position (xᵥ₁, yᵥ₁, zᵥ₁) of the virtual object 9120 before the operation for moving the viewpoint position is executed to the virtual object position (xᵥ₀, yᵥ₀, zᵥ₀) of the registered viewpoint information. Then, the processing proceeds to step S8030.

In step S8030, a viewpoint information setting unit 7040 acquires the moving amount of the virtual object from the moving amount calculation unit 7030, and sets the viewpoint position on which the acquired moving amount is reflected, to the viewpoint information. In other words, as illustrated in FIG. 9C, the viewpoint information setting unit 7040 adds the moving amount of the virtual object to the viewpoint position, and sets a viewpoint position (x₀+Δxᵥ, y₀+Δyᵥ, z₀+Δzᵥ) and the line-of-sight direction measured by the viewpoint information measurement unit 1010 to the viewpoint information. Then, the processing proceeds to step S2020.

According to the present exemplary embodiment, in the viewpoint moving operation of the mixed reality space, a moving operation for reproducing a relative position between the viewpoint position of the user and the position of the virtual object at the time of registration is possible.

In the third exemplary embodiment, the description has been given of the moving operation that is executed when a virtual object in a virtual space is moved in parallel to the world coordinate system. In a fourth exemplary embodiment, a description will be given of the moving operation that is to be executed when a virtual object in a virtual space is moved rotationally.

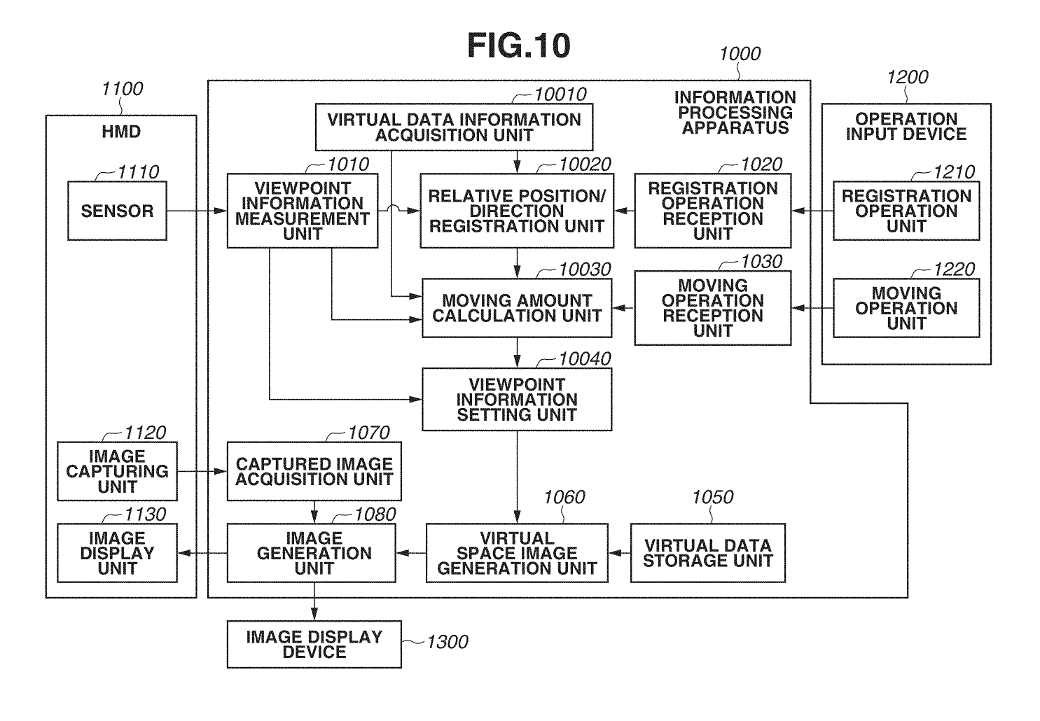

FIG. 10 is a block diagram illustrating an example of a functional configuration of a system according to the present exemplary embodiment. The same reference numerals are applied to the same constituent elements as those illustrated in FIG. 1, and the description thereof will be omitted.

A virtual data information acquisition unit 10010 acquires a position and a direction of a virtual object in the world coordinate system.

A relative position/direction registration unit 10020 registers the viewpoint position measured by a viewpoint information measurement unit 1010 and the position and the direction of the virtual object acquired by the virtual data information acquisition unit 10010, and stores a relative direction between the viewpoint position and the virtual object as a registered relative direction.

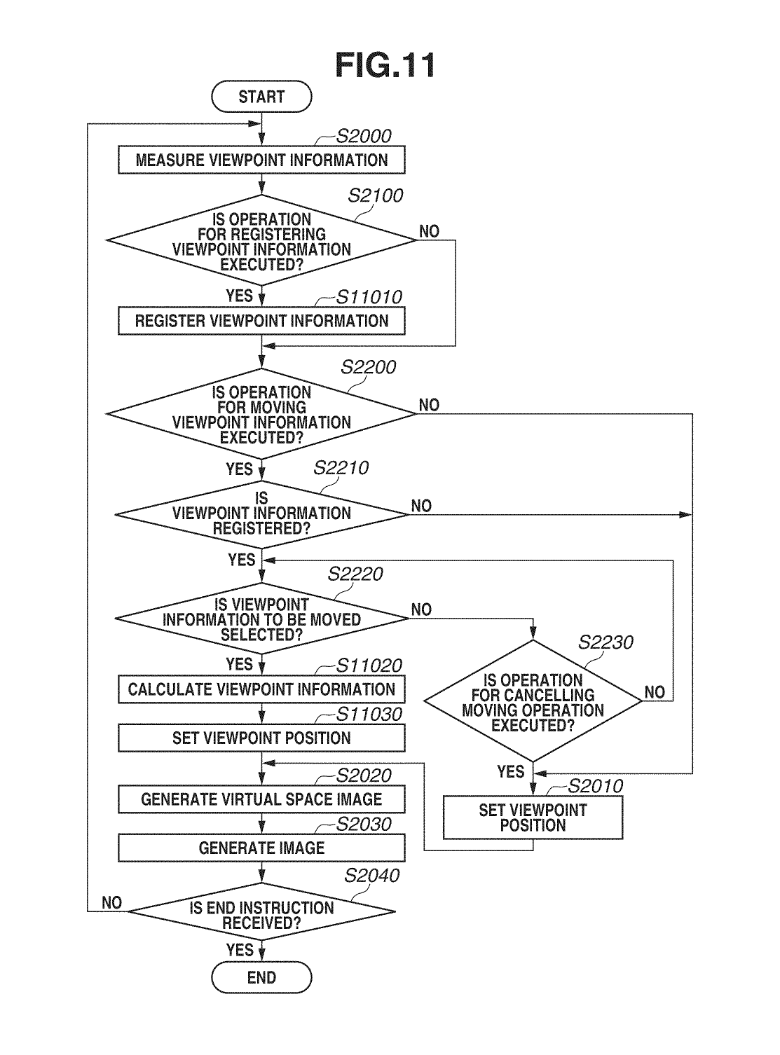

A moving amount calculation unit 10030 calculates a moving amount from the viewpoint position measured by the viewpoint information measurement unit 1010 so as to reproduce a relative relationship between the viewpoint position and the position and direction of the virtual object registered by the relative position/direction registration unit 10020. Details thereof will be described below with reference to a flowchart in FIG. 11.

FIG. 11 is a flowchart illustrating processing for moving the viewpoint position measured by the viewpoint information measurement unit 1010 based on the moving amount calculated by the moving amount calculation unit 10030, so as to reproduce a relative position between the viewpoint position and the position and the direction of the virtual object registered by the relative position/direction registration unit 10020. The same reference numerals are applied to the same constituent elements as those illustrated in FIG. 2, and the description thereof will be omitted.

In step S11010, the relative position/direction registration unit 10020 refers to the information from the viewpoint information measurement unit 1010 and registers the viewpoint position. Further, the relative position/direction registration unit 10020 refers to the information from the virtual data information acquisition unit 10010 and registers the position and the direction of the virtual object. The direction of the virtual object is defined by setting the position of the virtual object acquired from the virtual data information acquisition unit 10010 as an origin. Further, the direction of the virtual object is expressed by rotation angles (roll angle, pitch angle, and yaw angle) of respective axes in a coordinate system in which three axes orthogonal to each other are respectively defined as a roll axis, a pitch axis, and a yaw axis. At this time, the yaw axis has an axis in a gravitational direction. Then, the processing proceeds to step S2200.

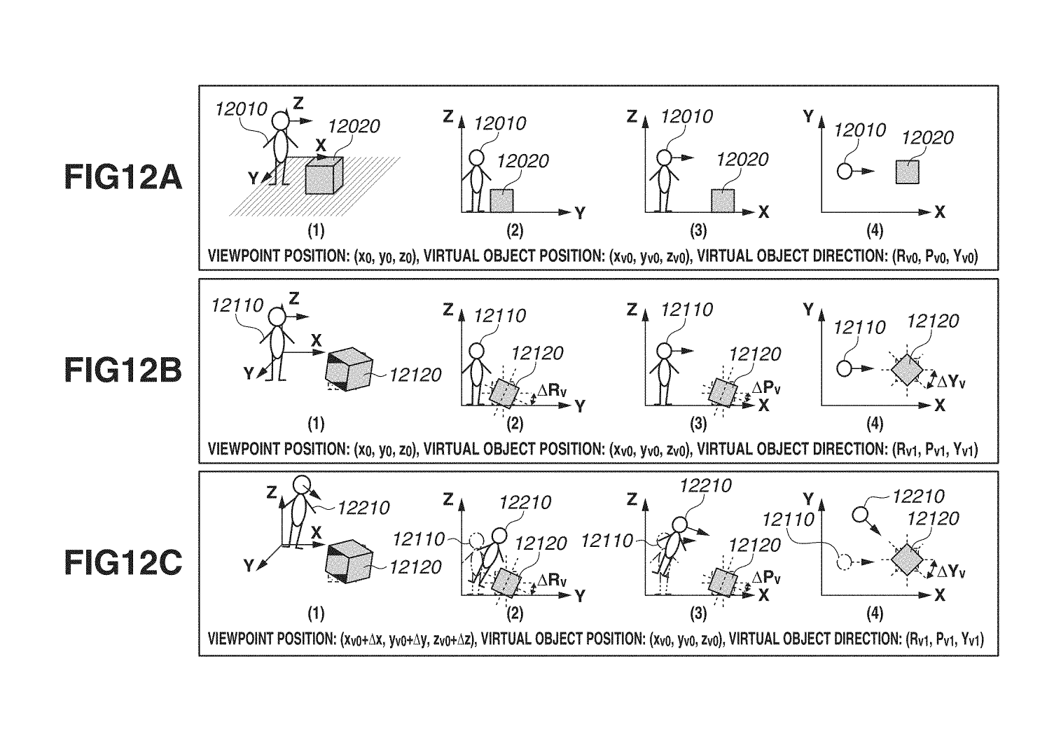

The processing performed in steps S11020 and S11030 will be described with reference to FIGS. 12A, 12B, and 12C.

FIGS. 12A, 12B, and 12C are diagrams illustrating an operation for moving the viewpoint position so as to reproduce a relative position between the viewpoint position of the registered viewpoint information and the position of the virtual object. FIG. 12A is a diagram illustrating a viewpoint position of a user 12010 and a virtual object 12020 at the time of registration. FIG. 12B is a diagram illustrating a viewpoint position of a user 12110 in the world coordinate system, which is the same as the viewpoint position at the time of registration, and a virtual object 12120 moved after the registration before the operation for moving the viewpoint position is executed. FIG. 12C is a diagram illustrating a viewpoint position of a user 12210 after executing the operation for moving the viewpoint position, a viewpoint position of the user 12110 before the moving operation, and the virtual object 12120 moved after the registration.

FIG. 12A (1) is a diagram three-dimensionally illustrating a virtual space at the time of registration. Further, FIG. 12A (2) is a diagram illustrating a state where FIG. 12A (1) is viewed in a direction of the X-axis, FIG. 12A (3) is a diagram illustrating a state where FIG. 12A (1) is viewed in a direction of the Y-axis, and FIG. 12A (4) is a diagram illustrating a state where FIG. 12A (1) is viewed from above in a direction of the Z-axis.

FIG. 12B (1) is a diagram three-dimensionally illustrating a virtual space before the operation for moving the viewpoint position is executed, in which a direction of the virtual object 12120 is rotationally moved after the registration. Further, FIG. 12B (2) is a diagram illustrating a state where FIG. 12B (1) is viewed in a direction of the X-axis, FIG. 12B (3) is a diagram illustrating a state where FIG. 12B (1) is viewed in a direction of the Y-axis, and FIG. 12B (4) is a diagram illustrating a state where FIG. 12B (1) is viewed from above in a direction of the Z-axis.

FIG. 12C (1) is a diagram three-dimensionally illustrating a virtual space after the operation for moving the viewpoint position is executed, which is illustrated in three dimensions. Further, FIG. 12C (2) is a diagram illustrating a state where FIG. 12C (1) is viewed in a direction of the X-axis, FIG. 12C (3) is a diagram illustrating a state where FIG. 12C (1) is viewed in a direction of the Y-axis, and FIG. 12C (4) is a diagram illustrating a state where FIG. 12C (1) is viewed from above in a direction of the Z-axis.

In step S11020, a viewpoint position of the registered viewpoint information selected in step S2220 is expressed as (x₀, y₀, z₀) in the world coordinate system, and a virtual object position is expressed as (xᵥ₀, yᵥ₀, zᵥ₀) in the world coordinate system. Further, a virtual object direction is expressed as (Rᵥₒ, Pᵥₒ, Yᵥₒ). A virtual object direction of the virtual object 12120 at the time of executing processing in step S11020, i.e., a virtual object direction thereof before the operation for moving the viewpoint position is executed, is expressed as (Rᵥ₁, Pᵥ₁, Yᵥ₁). The moving amount calculation unit 10030 calculates a moving amount (ΔRᵥ, ΔPᵥ, ΔYᵥ) for moving the virtual object direction (Rᵥ₁, Pᵥ₁, Yᵥ₁) of the virtual object 12120 before the operation for moving the viewpoint position is executed to the virtual object direction (Rᵥₒ, Pᵥₒ, Yᵥₒ) of the registered viewpoint information. As illustrated in FIG. 12C, in order to reproduce a relative position between the viewpoint position at the time of registration and the virtual object position, the viewpoint position of the user is rotationally moved around the virtual object as a center. At this time, a moving amount (Δx, Δy, Δz) of the viewpoint position can be acquired as follows.

$$[ \begin{matrix}Δ x \\ Δ y \\ Δ z\end{matrix} ] = {R}_{x} ( Δ {R}_{v} ) {R}_{Y} ( Δ {P}_{v} ) {R}_{z} ( Δ {Y}_{v} ) [ \begin{matrix}{x}_{0} - {x}_{v 0} \\ {y}_{0} - {y}_{v 0} \\ {z}_{0} - {z}_{v 0}\end{matrix} ] \\ {R}_{x} ( Δ {R}_{v} ) = [ \begin{matrix}1 & 0 & 0 \\ 0 & cos ( Δ {R}_{v} ) & - sin ( Δ {R}_{v} ) \\ 0 & sin ( Δ {R}_{v} ) & cos ( Δ {R}_{v} )\end{matrix} ] \\ {R}_{Y} ( Δ {P}_{v} ) = [ \begin{matrix}cos ( Δ {P}_{v} ) & 0 & sin ( Δ {P}_{v} ) \\ 0 & 1 & 0 \\ - sin ( Δ {P}_{v} ) & 0 & cos ( Δ {P}_{v} )\end{matrix} ] \\ {R}_{z} ( Δ {Y}_{v} ) = [ \begin{matrix}cos ( Δ {Y}_{v} ) & - sin ( Δ {Y}_{v} ) & 0 \\ sin ( Δ {Y}_{v} ) & cos ( Δ {Y}_{v} ) & 0 \\ 0 & 0 & 1\end{matrix} ] \qquad Formula 1$$

Then, the processing proceeds to step S11030.

In step S11030, the viewpoint information setting unit 10040 sets the viewpoint position on which the moving amount of the viewpoint position calculated by the moving amount calculation unit 10030 is reflected, to the viewpoint information. In other words, the viewpoint information setting unit 10040 sets a viewpoint position (xᵥ₀+Δx, yᵥ₀+Δy, zᵥ₀+Δz) in the world coordinates and the line-of-sight direction measured by the viewpoint information measurement unit 1010, to the viewpoint information. Then, the processing proceeds to step S2020.

According to the present exemplary embodiment, in the viewpoint moving operation of the mixed reality space, a moving operation for reproducing a relative position between the viewpoint position of the user and the position of the virtual object at the time of registration is possible.

In addition, the calculation method of the moving amount is merely an example, and any calculation method can be employed as long as the moving operation enables the viewpoint to be moved while maintaining a relative position between the users, and enables the user who executes the moving operation to move the line-of-sight direction to the line-of-sight direction of the user at the time of registration while maintaining the line-of-sight directions of the roll angle and the pitch angle. The viewpoint may be moved in parallel after being moved rotationally around the origin of the world coordinate system as the center, or may be moved in parallel after being moved rotationally around the viewpoint position of the movement-receiving user as the center.

In the first to the fourth exemplary embodiments, the description has been given of the exemplary embodiments in which one user executes the moving operation. In a fifth exemplary embodiment, a description will be given of a case where a plurality of users executes the moving operation concurrently.

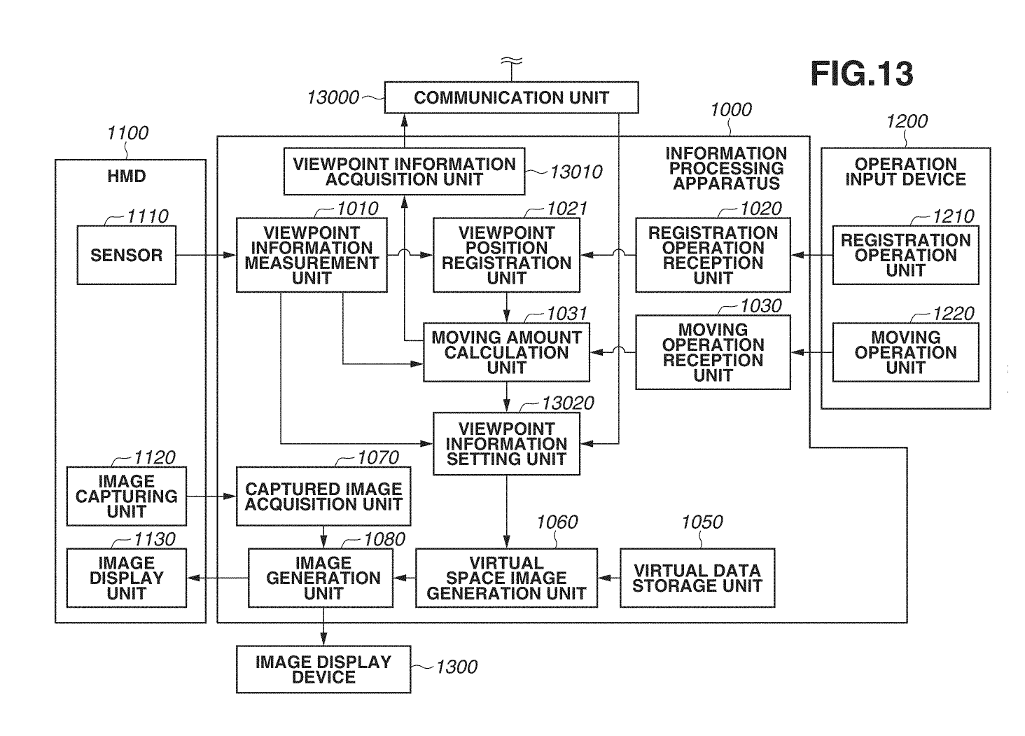

FIG. 13 is a block diagram illustrating an example of a functional configuration of a system according to the present exemplary embodiment. The same reference numerals are applied to the same constituent elements as those illustrated in FIG. 1, and the description thereof will be omitted.

A communication unit 13000 is connected to a network and executes communication with another computer. The communication unit 13000 transmits viewpoint information of a user to another computer.

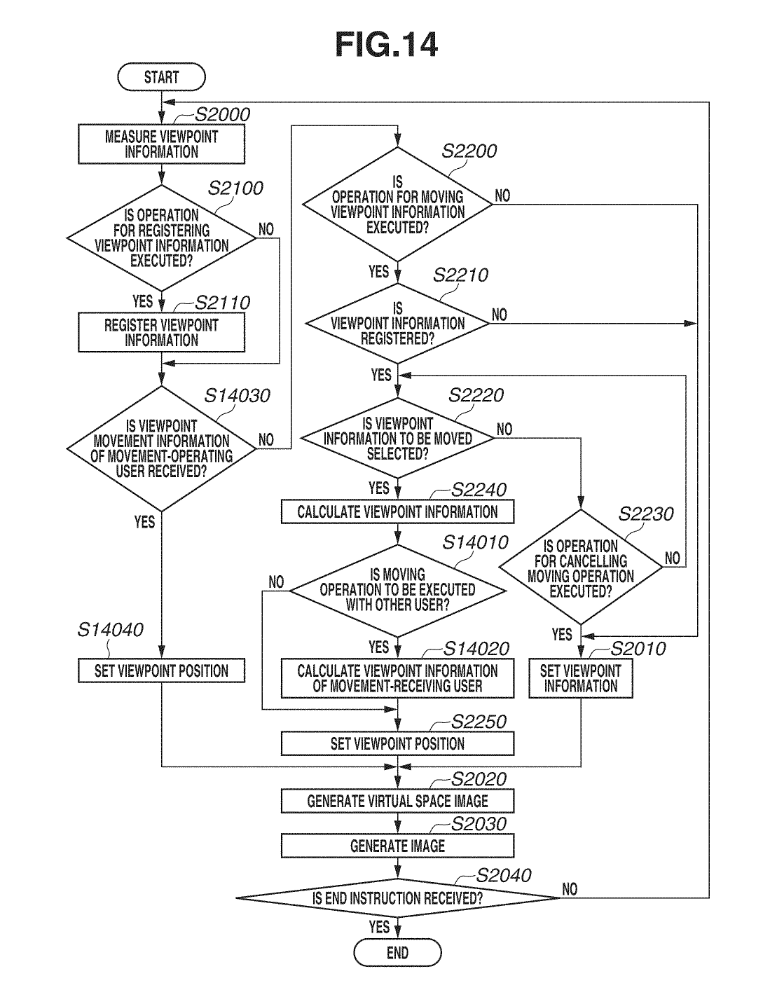

A viewpoint information acquisition unit 13010 acquires a moving amount of a movement-receiving user from a moving amount calculation unit 1031 so as to maintain a relative position between a user who executes the moving operation (movement-operating user) and a different user (movement-receiving user) in a real space before the moving operation. Details thereof will be described below with reference to a flowchart in FIG. 14.

When a viewpoint information setting unit 13020 receives an event from the communication unit 13000, the viewpoint information setting unit 13020 sets the viewpoint position on which the moving amount of the movement-operating user is reflected and the line-of-sight direction measured by a viewpoint information measurement unit 1010, to the viewpoint information. When a moving operation reception unit 1030 receives an event from a moving operation unit 1220, the viewpoint information setting unit 13020 sets the viewpoint position on which the moving amount input from the moving amount calculation unit 1031 is reflected and the line-of-sight direction measured by the viewpoint information measurement unit 1010, to the viewpoint information. In a case where the viewpoint information setting unit 13020 does not receive the event from the communication unit 13000 or the moving operation reception unit 1030 does not receive the event from the moving operation unit 1220, the viewpoint information setting unit 13020 sets the viewpoint position and the line-of-sight direction measured by the viewpoint information measurement unit 1010, to the viewpoint information. Then, the viewpoint information setting unit 13020 outputs the set viewpoint information to a virtual space image generation unit 1060.

FIG. 14 is a flowchart illustrating processing for moving a viewpoint position to a viewpoint position of the registered viewpoint information while maintaining a relative position between users when a plurality of users experiences a mixed reality space. The same reference numerals are applied to the same constituent elements as those illustrated in FIG. 2, and the description thereof will be omitted.

In step S14010, the moving operation reception unit 1030 refers to the input information from the moving operation unit 1220 and checks whether the operation to move a viewpoint position of one user together with another user is input. If the operation to move the viewpoint position of the one user together with the other user is input (YES in step S14010), the one user is set as a movement-operating user whereas the other user is set as a movement-receiving user, and then the processing proceeds to step S14020. On the other hand, if the operation to move the viewpoint position of the one user together with the other user is not input (NO in step S14010), the processing proceeds to step S2250.

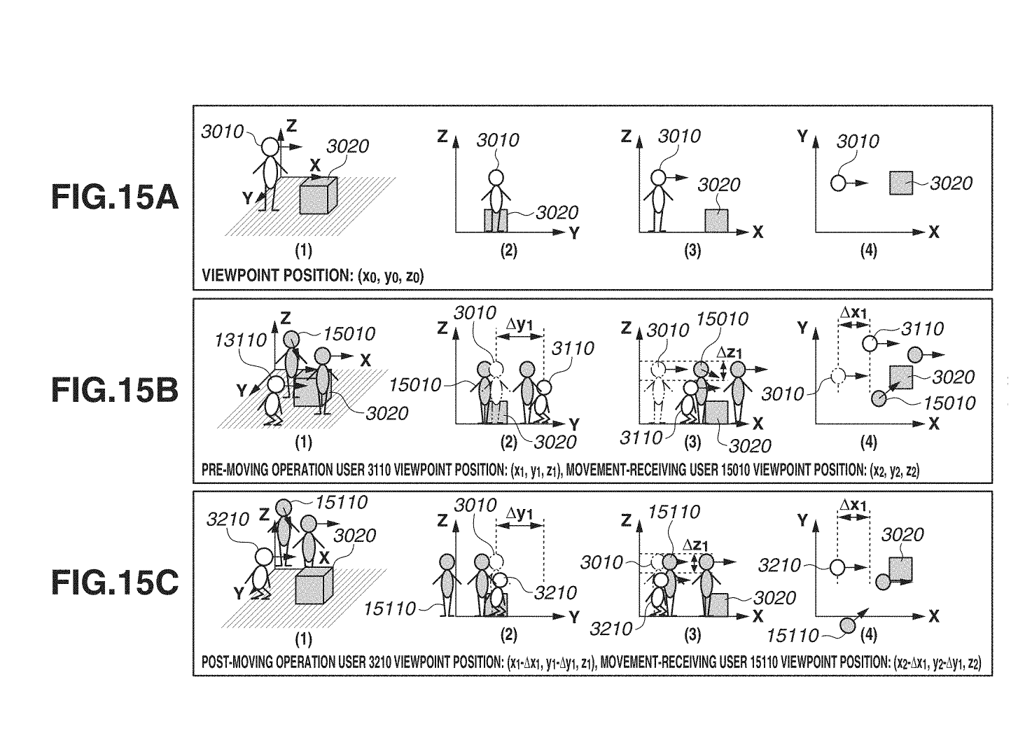

The processing in steps 514020 and 514030 will be described with reference to FIGS. 15A, 15B, and 15C.

FIGS. 15A, 15B, and 15C are diagrams illustrating an operation for moving the viewpoint position of the movement-operating user to the viewpoint position of the registered viewpoint information so as to maintain a relative position between the movement-receiving user and the movement-operating user. The same reference numerals are applied to the same constituent elements as those illustrated in FIGS. 3A, 3B, and 3C, and the description thereof will be omitted.

The constituent elements of FIG. 15A are the same as those in FIG. 3A. FIG. 15B is a diagram illustrating a movement-operating user 3110 and a movement-receiving user 15010 before the moving operation, a virtual object 3020, and a user 3010 at the time of registration in the virtual space before the operation for moving the viewpoint position is executed, when a plurality of users experiences a mixed reality space. FIG. 15C is a diagram illustrating a movement-operating user 3210 and a movement-receiving user 15110 after the moving operation, the virtual object 3020, and the user 3010 at the time of registration in the virtual space after the operation for moving the viewpoint position is executed.

FIG. 15B (1) is a diagram three-dimensionally illustrating a virtual space before the operation for moving the viewpoint position is executed, which is illustrated in three dimensions. Further, FIG. 15B (2) is a diagram illustrating a state where FIG. 15B (1) is viewed in a direction of the X-axis, FIG. 15B (3) is a diagram illustrating a state where FIG. 15B (1) is viewed in a direction of the Y-axis, and FIG. 15B (4) is a diagram illustrating a state where FIG. 15B (1) is viewed from above in a direction of the Z-axis.

FIG. 15C (1) is a diagram three-dimensionally illustrating a virtual space after the operation for moving the viewpoint position is executed, which is illustrated in three dimensions. Further, FIG. 15C (2) is a diagram illustrating a state where FIG. 15C (1) is viewed in a direction of the X-axis, FIG. 15C (3) is a diagram illustrating a state where FIG. 15C (1) is viewed in a direction of the Y-axis, and FIG. 15C (4) is a diagram illustrating a state where FIG. 15C (1) is viewed from above in a direction of the Z-axis.

In step S14020, the viewpoint information acquisition unit 13010 acquires a viewpoint position of the user 3110 before the movement-operating user executes the moving operation as (x₁, y₁, z₁), and acquires a viewpoint position of the user 3010 at the time of registration as (x₀, y₀, z₀). The viewpoint information acquisition unit 13010 acquires a moving amount (Δx₁, Δy₁, Δz₁) for moving the viewpoint position (x₁, y₁, z₁) of the user 3110 before the moving operation to the viewpoint position (x₀, y₀, z₀) of the user 3010 at the time of registration. Further, the viewpoint information acquisition unit 13010 outputs the acquired moving amount (Δx₁, Δy₁, Δz₁) to the communication unit 13000. Then, the processing proceeds to step S2250.

In step S14030, the viewpoint information setting unit 13020 checks whether viewpoint movement information of the movement-operating user is received from the communication unit 13000. If the viewpoint movement information of the movement-operating user is received (YES in step S14030), the viewpoint information setting unit 13020 determines the user as the movement-receiving user, and the processing proceeds to step S14040. If the viewpoint movement information of the movement-operating user is not received (NO in step S14030), the processing proceeds to step S2200.

In step S14040, the viewpoint information setting unit 13020 sets the viewpoint position on which the moving amount (Δx₁, Δy₁, Δz₁) of the movement-operating user received from the communication unit 13000 is reflected, to the viewpoint information. The viewpoint information setting unit 13020 sets the viewpoint position of the movement-receiving user before the moving operation as (x₂, y₂, z₂) in the world coordinates. As illustrated in FIG. 15C, the viewpoint information setting unit 13020 sets a viewpoint position (x₂−Δx₁, y₂−Δy₁, z₂) and the line-of-sight direction measured by the viewpoint information measurement unit 1010, to the viewpoint information so as to set the viewpoint position of the movement-receiving user 15110 to have a current viewpoint height. Then, the processing proceeds to step S2020.

In the present exemplary embodiment, when a plurality of users experiences the mixed reality space, the operation for moving the viewpoint position is executed so as to maintain a viewpoint height of each of users and a relative position between the users. Further, the user who executes the moving operation can provide a moving operation for moving the viewpoint position to the viewpoint position of the user at the time of registration.

In the fifth exemplary embodiment, the description has been given of the moving operation of a plurality of users executed when the viewpoint position is moved in parallel after the registration. In a sixth exemplary embodiment, a description will be given of a moving operation of a plurality of users executed when the line-of-sight direction is moved.

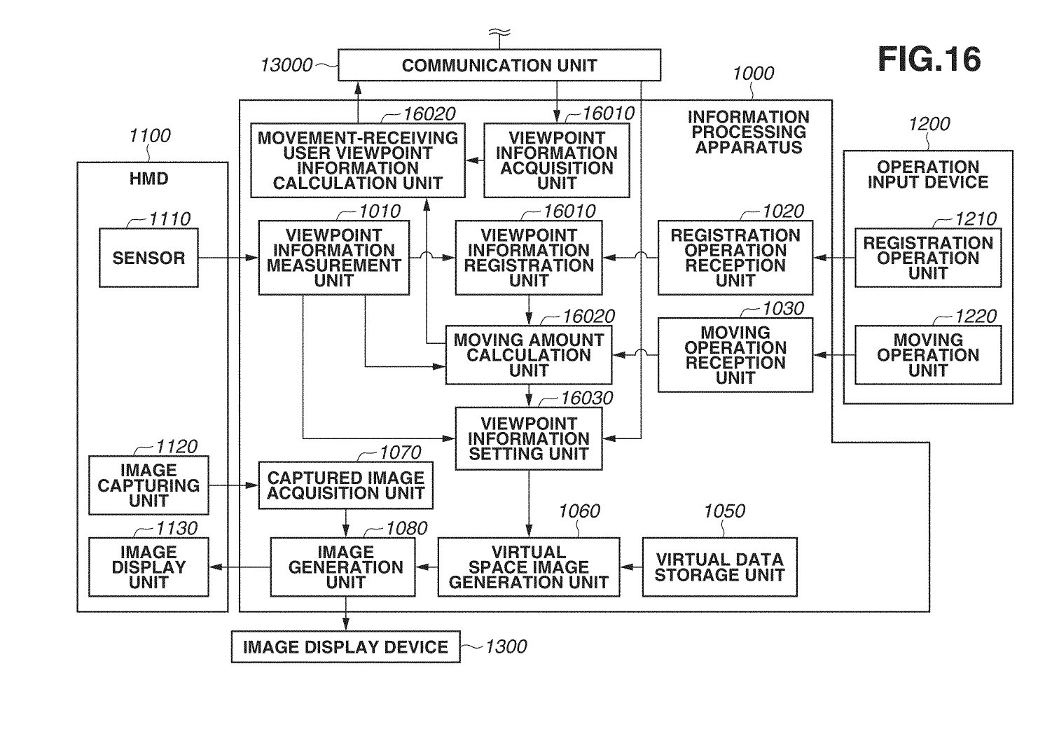

FIG. 16 is a block diagram illustrating an example of a functional configuration of a system according to the present exemplary embodiment. The same reference numerals are applied to the same constituent elements as those illustrated in FIG. 13, and the description thereof will be omitted.

A viewpoint information acquisition unit 16010 acquires viewpoint information of a user (movement-receiving user) who are using an information processing apparatus 1000 connected to another computer via the communication unit 13000.

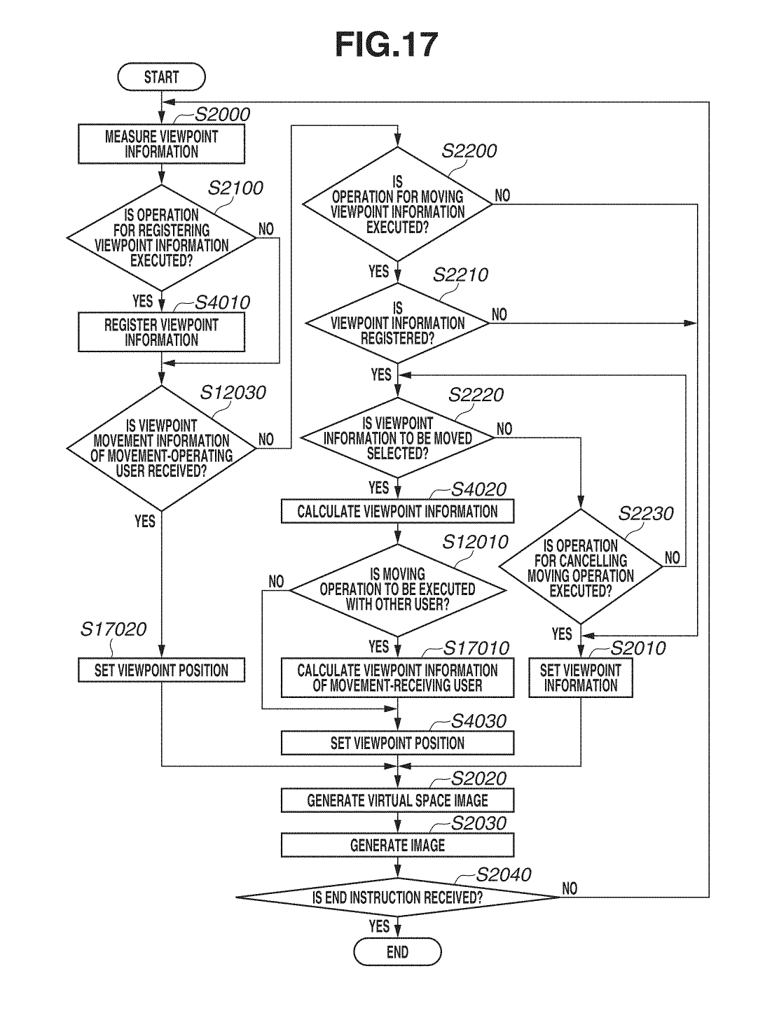

A moving amount calculation unit 16020 calculates a moving amount of the movement-receiving user so as to maintain a relative position between a user (movement-operating user) who executes the moving operation and the movement-receiving user in a real space before the moving operation. Details thereof will be described below with reference to a flowchart in FIG. 17.

When a viewpoint information setting unit 16030 receives an event from the communication unit 13000, the viewpoint information setting unit 16030 sets a viewpoint position on which the moving amount of the movement-operating user is reflected and the line-of-sight direction measured by a viewpoint information measurement unit 1010, to the viewpoint information. When a moving operation reception unit 1030 receives an event from a moving operation unit 1220, the viewpoint information setting unit 16030 sets a viewpoint position on which the moving amount input from the moving amount calculation unit 1031 is reflected and the line-of-sight direction measured by the viewpoint information measurement unit 1010, to the viewpoint information. In a case where the viewpoint information setting unit 16030 does not receive the event from the communication unit 13000 or the moving operation reception unit 1030 does not receive the event from the moving operation unit 1220, the viewpoint information setting unit 16030 sets the viewpoint position and the line-of-sight direction measured by the viewpoint information measurement unit 1010, to the viewpoint information. Then, the viewpoint information setting unit 16030 outputs the set viewpoint information to a virtual space image generation unit 1060.

FIG. 17 is a flowchart illustrating processing for moving the line-of-sight direction to the line-of-sight direction of the registered viewpoint information while maintaining a relative position between the users, which is executed in the present exemplary embodiment when a plurality of users experiences the mixed reality space. The same reference numerals are applied to the same constituent elements as those illustrated in FIG. 14, and the description thereof will be omitted.

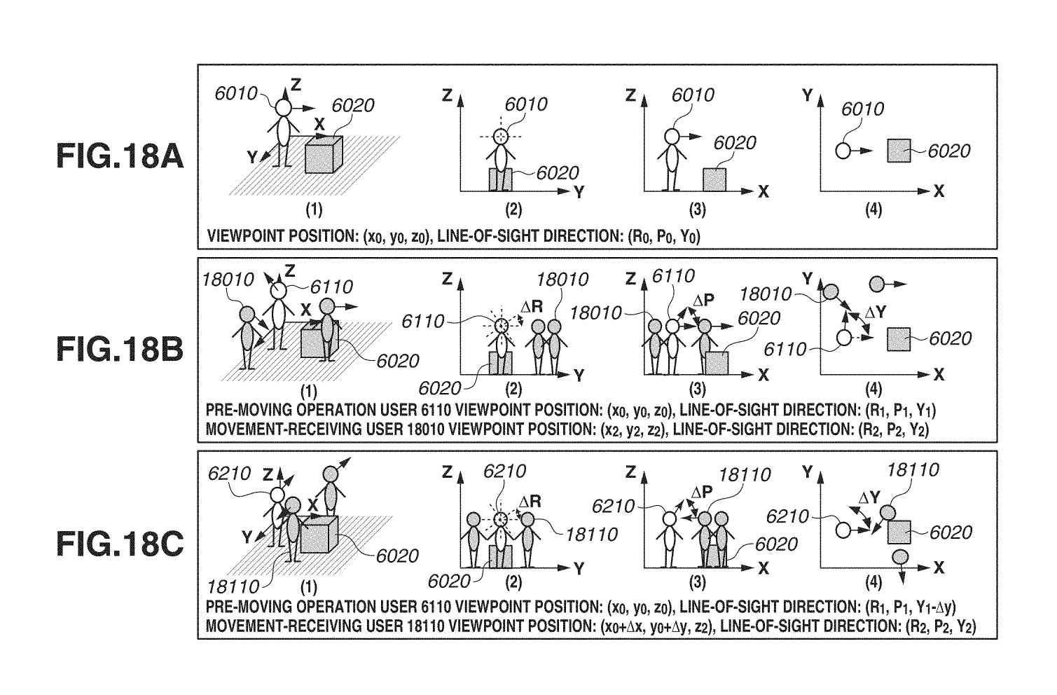

The processing in steps S17010 and S17020 will be described with reference to FIGS. 18A, 18B, and 18C.

FIGS. 18A, 18B, and 18C are diagrams illustrating an operation for moving the line-of-sight direction of the movement-operating user to the line-of-sight direction of the registered viewpoint information while maintaining a relative position between the movement-receiving user and the movement-operating user. The same reference numerals are applied to the same constituent elements as those illustrated in FIGS. 6A, 6B, and 6C, and the description thereof will be omitted. Further, the line-of-sight direction is defined by setting a viewpoint position of each user as an origin. Further, the line-of-sight direction is expressed by rotation angles (roll angle, pitch angle, and yaw angle) of respective axes in a coordinate system in which three axes orthogonal to each other are respectively defined as a roll axis, a pitch axis, and a yaw axis. At this time, the yaw axis has an axis in a gravitational direction.

The constituent elements of FIG. 18A are the same as those in FIG. 6A. FIG. 18B is a diagram illustrating a movement-operating user 6110, a movement-receiving user 18010, and a virtual object 6020 before the moving operation of the viewpoint position is executed when a plurality of users experiences the mixed reality space. FIG. 18C is a diagram illustrating a movement-operating user 6210 and a movement-receiving user 18110 after the moving operation, and a virtual object 6020 in the virtual space after the moving operation of the viewpoint position is executed.

FIG. 18B (1) is a diagram three-dimensionally illustrating a virtual space before the moving operation of the viewpoint position is executed, which is illustrated in three dimensions. Further, FIG. 18B (2) is a diagram illustrating a state where FIG. 18B (1) is viewed in a direction of the X-axis, FIG. 18B (3) is a diagram illustrating a state where FIG. 18B (1) is viewed in a direction of the Y-axis, and FIG. 18B (4) is a diagram illustrating a state where FIG. 18B (1) is viewed from above in a direction of the Z-axis.

FIG. 18C (1) is a diagram three-dimensionally illustrating a virtual space after the moving operation of the viewpoint position is executed, which is illustrated in three dimensions. Further, FIG. 18C (2) is a diagram illustrating a state where FIG. 18C (1) is viewed in a direction of the X-axis, FIG. 18C (3) is a diagram illustrating a state where FIG. 18C (1) is viewed in a direction of the Y-axis, and FIG. 18C (4) is a diagram illustrating a state where FIG. 18C (1) is viewed from above in a direction of the Z-axis.

In step S17020, the moving amount calculation unit 16020 acquires a moving amount (AR, AP, AY) for moving the line-of-sight direction of the movement-operating user 6110 before the moving operation to the line-of-sight direction of the user 6010 at the time of registration. As illustrated in FIG. 18C, when the line-of-sight direction of the movement-operating user is moved in the line-of-sight direction of the registered viewpoint information, the viewpoint position of the movement-receiving user is moved rotationally around the movement-operating user as the center in order to maintain a relative position between the users. At this time, in order not to impair the sense of reality of the user, only the rotation about the yaw axis of the movement-operating user is reflected. The viewpoint position of the user 6110 before the moving operation is (x₀, y₀, z₀), which is the same as the viewpoint position of the user 6010 at the time of registration. At this time, if the viewpoint position and the line-of-sight direction of the movement-receiving user 18010 before the moving operation are respectively (x₂, y₂, z₂) and (R₂, P₂, Y₂), a moving amount (Δx, Δy, Δz) of the viewpoint position of the movement-receiving user 18010 can be acquired as follows.

$$[ \begin{matrix}Δ x \\ Δ y \\ Δ z\end{matrix} ] = {R}_{z} ( Δ Y ) [ \begin{matrix}{x}_{2} - {x}_{0} \\ {y}_{2} - {y}_{0} \\ {z}_{2} - {z}_{0}\end{matrix} ] \\ {R}_{z} ( Δ Y ) = [ \begin{matrix}cos ( Δ Y ) & - sin ( Δ Y ) & 0 \\ sin ( Δ Y ) & cos ( Δ Y ) & 0 \\ 0 & 0 & 1\end{matrix} ] \qquad Formula 2$$

The moving amount calculation unit 16020 calculates the viewpoint position (x₀+Δx, y₀+Δy, z₂) of the movement-receiving user 18110 in the world coordinates and outputs the viewpoint position (x₀+Δx, y₀+Δy, z₂) to the communication unit 13000. Then, the processing proceeds to step S4030.

In step S17020, the viewpoint information setting unit 16030 sets the viewpoint position (x₀+Δx, y₀+Δy, z₂) received from the communication unit 13000 and the line-of-sight direction measured by the viewpoint information measurement unit 1010, to the viewpoint information. Then, the processing proceeds to step S2020.

In the present exemplary embodiment, when a plurality of users experiences the mixed reality space, the viewpoint moving operation is executed so as to maintain a relative position between the users. Further, the user who executes the moving operation can provide the moving operation for moving the line-of-sight direction to the line-of-sight direction of the user at the time of registration while maintaining the line-of-sight directions of the roll angle and the pitch angle.

In addition, the calculation method of the moving amount is merely an example, and any calculation method can be employed as long as the moving operation enables the viewpoint to be moved while maintaining a relative position between the users and enables the user who executes the moving operation to move the line-of-sight direction to the line-of-sight direction of the user at the time of registration while maintaining the line-of-sight directions of the roll angle and the pitch angle. The viewpoint may be moved in parallel after being moved rotationally around the origin of the world coordinate system as the center, or may be moved in parallel after being moved rotationally around the viewpoint position of the movement-receiving user at the center.

### MODIFICATION EXAMPLE 5

In the fifth and the sixth exemplary embodiments, the description has been given of the exemplary embodiments in which the moving operation is executed while all of the users other than the movement-operating user are set as the movement-receiving users when a plurality of users experiences the mixed reality space. However, the present invention is not limited thereto. In other words, the movement-operating user may select a movement-receiving user who moves together with the movement-operating user from a plurality of users, or a user who selects to move together with the movement-operating user may be set as the movement-receiving user by displaying a dialog for prompting the users other than the movement-operating user to select whether to move together with the movement-operating user.

### MODIFICATION EXAMPLE 6

In the above-described exemplary embodiments, the user executes the viewpoint moving operation by using the viewpoint information registered in the mixed reality space. However, the present invention is not limited thereto. More specifically, the user may use the viewpoint information registered by the system, or may use the viewpoint information registered by the user in the virtual space.

### MODIFICATION EXAMPLE 7

In the above-described exemplary embodiments, the viewpoint moving operation has been executed in any of the cases in which a viewpoint position or a line-of-sight direction is changed after the viewpoint registration, or a position or a direction of the virtual object in the virtual space is changed after the viewpoint registration. However, the present invention is not limited thereto. More specifically, if the viewpoint position and the line-of-sight direction or the position and the direction of the virtual object are changed, by combining the above-described exemplary embodiments, the moving operation that reflects only the rotation about the yaw axis of the line-of-sight direction may be executed while maintaining the viewpoint height. Further, the moving operation may be executed so as to reproduce a relative position between the virtual object and the user.

### MODIFICATION EXAMPLE 8

In each of the above-described exemplary embodiments, although viewpoint information of the HMD has been used as the viewpoint information, the present invention is not limited thereto. More specifically, a viewpoint position and a line-of-sight direction in which walk-through movement implemented by an input device such as a game controller, a mouth, or a keyboard is added to the viewpoint information of the HMD, may be used. In addition, the moving operation is executed by reflecting only the rotation about the yaw axis of the line-of-sight direction while maintaining the viewpoint height of the HMD.

### MODIFICATION EXAMPLE 9

In each of the above-described exemplary embodiments, when a position and a direction of the virtual object are moved after the registration, the operation for moving the viewpoint position has been executed without moving the virtual object. However, the present invention is not limited thereto. More specifically, a relative position between the viewpoint position and the line-of-sight direction of the user and the position and the direction of the virtual object at the time of registration may be reproduced by moving the position and the direction of the virtual object.

### MODIFICATION EXAMPLE 10

In each of the above-described exemplary embodiments, the description has been given of an exemplary embodiment which is applied to a mixed reality (MR) system for displaying an image in which a virtual image is combined with a captured image. However, the present invention is not limited thereto. For example, the embodiments can be applied to a virtual reality (VR) system for displaying only a virtual image. In such a case, in each of the above exemplary embodiments, the image generation unit 1080 may function to simply display a virtual space image on an image display device 1300 without superimposing the virtual image onto the real space image acquired by the captured image acquisition unit 1070. Then, in a case where the embodiment is applied to the above-described VR system, markers may be arranged in a real space (an arrangement information of the markers is known), and viewpoint information may be measured by using images of the markers captured by the image capturing unit 1120. A measurement method of the viewpoint information using the markers is widely known, so that the description thereof is omitted. Obviously, the captured image acquisition unit 1070 is not necessary if the viewpoint information is measured by using the sensor 1110.

While exemplary embodiments have been described, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2016-016364, filed Jan. 29, 2016, which is hereby incorporated by reference herein in its entirety.

What is claimed is:

1. An information processing apparatus, comprising:
a viewpoint information storage unit configured to store viewpoint information for observing a virtual object as registered viewpoint information;
a viewpoint position acquisition unit configured to acquire viewpoint information of a display apparatus mounted on a part of a body of a user;
a setting unit configured to set viewpoint information for the user to observe a virtual object based on the registered viewpoint information and the acquired viewpoint information;
a generation unit configured to generate a virtual image including a virtual object based on a viewpoint indicated by the set viewpoint information; and
a display control unit configured to display the generated virtual image on the display apparatus.

2. The information processing apparatus according to claim 1, wherein the viewpoint information is information indicating a position or an orientation of a viewpoint.

3. The information processing apparatus according to claim 2, wherein the setting unit sets the viewpoint information for the user to observe a virtual object based on a part of components indicating a position and an orientation of the viewpoint indicated by the registered viewpoint information and a part of components indicating a position and an orientation of the viewpoint indicated by the acquired viewpoint information.

4. The information processing apparatus according to claim 3, wherein a height component of the position of the viewpoint indicated by the acquired viewpoint information is set as the height component of the position of the viewpoint indicated by the acquired viewpoint information.

5. The information processing apparatus according to claim 4, wherein components other than the height component of the viewpoint position indicated by the registered viewpoint information are set as the components other than the height component of the viewpoint position indicated by the acquired viewpoint information.

6. The information processing apparatus according to claim 5, further comprising a calculation unit configured to calculate a difference amount between the position of the viewpoint indicated by the acquired viewpoint information and the position of the viewpoint indicated by the registered viewpoint information,
wherein, the setting unit sets the viewpoint information for observing the virtual object by changing the position of the viewpoint indicated by the acquired viewpoint information by the difference amount with respect to the components other than the height component.

7. The information processing apparatus according to claim 3, wherein a yaw axis rotation component of the line-of-sight direction is set to a yaw rotation axis component of an orientation of the viewpoint indicated by the acquired viewpoint information.

8. The information processing apparatus according to claim 7, wherein components other than the yaw axis rotation component of the registered line-of-sight direction is set to components other than the yaw axis rotation component of the orientation of the viewpoint indicated by the acquired viewpoint information.

9. The information processing apparatus according to claim 8, further comprising a calculation unit configured to calculate a difference amount between the orientation of the viewpoint indicated by the acquired viewpoint information and the orientation of the viewpoint indicated by the registered viewpoint information,
wherein the setting unit sets the viewpoint information for observing the virtual object by changing the orientation of the viewpoint indicated by the acquired viewpoint information by the difference amount with respect to the components other than the yaw axis rotation component.

10. The information processing apparatus according to claim 1, further comprising a captured image acquisition unit configured to acquire a captured image of a real space captured by an image capturing unit,
wherein the viewpoint information acquisition unit acquires the viewpoint information based on feature information extracted from the captured image.

11. The information processing apparatus according to claim 1, wherein the viewpoint information acquisition unit acquires the viewpoint information based on a magnetic sensor, an infrared sensor, an ultrasonic sensor, or a depth sensor.

12. The information processing apparatus according to claim 1, further comprising a changing unit configured to change viewpoint information of a different user different from the user based on the set viewpoint information.

13. The information processing apparatus according to claim 1, wherein the display apparatus is a head-mounted display apparatus.

14. An information processing apparatus comprising:
a viewpoint information storage unit configured to store a relative position between a viewpoint position for observing a virtual object and a position of the virtual object as a registered relative position;
a viewpoint information acquisition unit configured to acquire a relative position between a viewpoint position of a display apparatus mounted on a part of a body of a user and a current position of the virtual object;
a setting unit configured to set a viewpoint position for the user to observe the virtual object so as to match the acquired relative position with the registered relative position;
a generation unit configured to generate a virtual image including a virtual object based on the set viewpoint position; and
a display control unit configured to display the generated virtual image on the display apparatus.

15. The information processing apparatus according to claim 14,
wherein the viewpoint information storage unit further stores a relative orientation between an orientation of the viewpoint for observing the virtual object and an orientation of the virtual object as a registered relative orientation,
wherein the viewpoint information acquisition unit further acquires a relative orientation between an orientation of the acquired viewpoint of a display apparatus mounted on a part of a body of a user and a orientation of the virtual object,
wherein the setting unit further sets an orientation of a viewpoint for the user to observe the virtual object to match the acquired relative orientation with the registered relative orientation, and
wherein the generation unit further generates the virtual image based on the set orientation of the viewpoint.

16. The information processing apparatus according to claim 14, further comprising a captured image acquisition unit configured to acquire a captured image of a real space captured by an image capturing unit,
wherein the viewpoint information acquisition unit acquires the viewpoint information based on feature information extracted from the captured image.

17. The information processing apparatus according to claim 14, wherein the viewpoint information acquisition unit acquires the viewpoint information based on a magnetic sensor, an infrared sensor, an ultrasonic sensor, or a depth sensor.

18. The information processing apparatus according to claim 14, further comprising a changing unit configured to change a line-of-sight direction of a different user different from the user based on the set line-of-sight direction.

19. The information processing apparatus according to claim 14, wherein the display apparatus is a head-mounted display apparatus.

20. A control method for an information processing apparatus storing viewpoint information for observing a virtual object as registered viewpoint information, the control method comprising:
acquiring viewpoint information of a display apparatus mounted on a part of a body of a user;
setting viewpoint information for the user to observe a virtual object based on the registered viewpoint information and the acquired viewpoint information;
generating a virtual image including a virtual object based on a viewpoint indicated by the set viewpoint information; and
displaying the generated virtual image on the display apparatus.

21. A control method for an information processing apparatus storing a relative position between a viewpoint position for observing a virtual object and a position of the virtual object as a registered relative position, the control method comprising:
acquiring a relative position between a viewpoint position of a display apparatus mounted on a part of a body of a user and a position of a virtual object;
setting a viewpoint position for the user to observe the virtual object so as to match the acquired relative position with the registered relative position;
generating a virtual image including a virtual object based on the set viewpoint position; and
displaying the generated virtual image on the display apparatus.

22. A computer readable storage medium storing a program for causing a computer to function as respective units of an information processing apparatus, the information processing apparatus comprising:
a viewpoint information storage unit configured to store viewpoint information for observing a virtual object as registered viewpoint information;
a viewpoint position acquisition unit configured to acquire viewpoint information of a display apparatus mounted on a part of a body of a user;
a setting unit configured to set viewpoint information for the user to observe the virtual object based on the registered viewpoint information and the acquired viewpoint information;
a generation unit configured to generate a virtual image including the virtual object based on a viewpoint indicated by the set viewpoint information; and
a display control unit configured to display the generated virtual image on the display apparatus.

23. A computer readable storage medium storing a program for causing a computer to function as respective units of an information processing apparatus, the information processing apparatus comprising:
a viewpoint information storage unit configured to store a relative position between a viewpoint position for observing a virtual object and a position of the virtual object as a registered relative position;
a viewpoint information acquisition unit configured to acquire a relative position between a viewpoint position of a display apparatus mounted on a part of a body of a user and a position of the virtual object;
a setting unit configured to set a viewpoint position for the user to observe a virtual object so as to match the acquired relative position with the registered relative position;
a generation unit configured to generate a virtual image including a virtual object based on the set viewpoint position; and
a display control unit configured to display the generated virtual image on the display apparatus.
